(19) United States
(12) Patent Application Publication
(10) Pub. No.: US 2016/0277595 A1
(43) Pub. Date: Sep. 22, 2016

(54) FACSIMILE APPARATUS, IMAGE TRANSMISSION METHOD, AND COMPUTER-READABLE RECORDING MEDIUM

(71) Applicants: Itaru KODAIRA, Kanagawa (JP); Makoto SASAKI, Kanagawa (JP); Junki AOKI, Kanagawa (JP); Takuya MORI, Tokyo (JP); Yukinori ISHll, Kanagawa (JP); Hiroaki IKKANZAKA, Tokyo (JP); Tomohiro KUROYANAGI, Kanagawa (JP); Fumiyoshi KITTAKA, Kanagawa (JP); Koichiro MAEMURA, Kanagawa (JP)

(72) Inventors: Itaru KODAIRA, Kanagawa (JP); Makoto SASAKI, Kanagawa (JP); Junki AOKI, Kanagawa (JP); Takuya MORI, Tokyo (JP); Yukinori ISHll, Kanagawa (JP); Hiroaki IKKANZAKA, Tokyo (JP); Tomohiro KUROYANAGI, Kanagawa (JP); Fumiyoshi KITTAKA, Kanagawa (JP); Koichiro MAEMURA, Kanagawa (JP)

(73) Assignee: Ricoh Company, Limited, Tokyo (JP)

(21) Appl. No.: 15/064,042

(22) Filed: Mar. 8, 2016

(30) Foreign Application Priority Data
Mar. 16, 2015 (JP) 2015-052575

(51) Int. Cl. H04N 1/00

(52) U.S. Cl. CPC H04N 1/0022; H04N 1/001; H04N 2201/0093; H04N 2201/0013; H04N 2201/3201; H04N 2201/3278

(57) ABSTRACT

A facsimile apparatus includes: a first receiver that receives, from any one of at least one child device, a first image, transmission-destination-information, and transmission-source-information-processing-apparatus-identifying-information; a first transmitter that transmits a facsimile of the first image to the transmission destination represented by the transmission-destination-information; a registration unit that registers transfer information that associates, with each other, first-transmission-source-information where a transmission source is the transmission destination represented by the transmission-destination-information and transfer-destination-information-processing-apparatus-identifying-information where a transfer destination is the information processing apparatus represented by the transmission-source-information-processing-apparatus-identifying-information; a second receiver that receives a facsimile of a second image and second-transmission-source-information representing a transmission source from which the second image is transmitted; and a second transmitter that, when the transmission source represented by the second-transmission-source-information matches the transmission source represented by the first-transmission-source-information, transmits the second image to the child device represented by the transfer-destination-information-processing-apparatus-identifying-information that is associated with the first-transmission-source-information.

### CROSS-REFERENCE TO RELATED APPLICATIONS

The present application claims priority to and incorporates by reference the entire contents of Japanese Patent Application No. 2015-052575 filed in Japan on Mar. 16, 2015.

### BACKGROUND OF THE INVENTION

1. Field of the Invention

The present invention relates generally to a facsimile apparatus, an image transmission method, and a computer-readable recording medium.

2. Description of the Related Art

A technology is known in which a parent device that is a facsimile apparatus connected to a public line and a child device that is an image processing apparatus not connected to the public line are connected to each other via, for example, a local area network (LAN) to transmit a facsimile from the child device not connected to the public line to the outside and to receive a facsimile from the outside at the child device not connected to the public line.

For example, Japanese Laid-open Patent Publication No. 2014-192601 discloses a technology in which a parent device transfers externally-transmitted facsimiles to child devices by using a reception refusal/permission table that associates telephone numbers each serving as a transmission source from which a facsimile is externally transmitted with the IP addresses of child devices each serving as a transfer destination to which a facsimiles is transferred.

The above-described conventional technology requires registration of the telephone numbers serving as transmission sources and the IP addresses of child devices serving as transfer destinations in advance in the reception refusal/permission table to transfer facsimiles transmitted from transmission sources to intended child devices and therefore there is still a need for improvement to enhance convenience.

In view of the above-described circumstances, there is a need to provide a facsimile apparatus, an image transmission method, and a computer-readable recording medium having a computer program that can enhance convenience.

### SUMMARY OF THE INVENTION

It is an object of the present invention to at least partially solve the problems in the conventional technology.

Exemplary embodiments of the present invention, there is provided a facsimile apparatus comprising: a first receiver that receives, from any one of at least one information processing apparatus via an internal network, a first image, transmission-destination-information representing a transmission destination to which the first image is to be transmitted, and transmission-source-information-processing-apparatus-identifying-information representing an information processing apparatus serving as a transmission source from which the first image is transmitted; a first transmitter that transmits a facsimile of the first image to the transmission destination represented by the transmission-destination-information via an external network; a registration unit that registers, in a transfer information storage unit, transfer information that associates, with each other, first-transmission-source information where a transmission source is the transmission destination represented by the transmission-destination-information and transfer-destination-information-processing-apparatus-identifying-information where a transfer destination is the information processing apparatus represented by the transmission-source-information-processing-apparatus-identifying-information; a second receiver that receives, via the external network, a facsimile of a second image and second transmission-source-information representing a transmission source from which the second image is transmitted; and a second transmitter that, when the transmission source represented by the second-transmission-source-information matches the transmission source represented by the first-transmission-source-information, transmits the second image via the internal network to the information processing apparatus represented by the transfer-destination-information-processing-apparatus-identifying-information that is associated with the first-transmission-source-information.

Exemplary embodiments of the present invention also provide an image transmission method comprising: receiving, from any one of at least one information processing apparatus via an internal network, a first image, transmission-destination-information representing a transmission destination to which the first image is to be transmitted, and transmission-source-information-processing-apparatus-identifying-information representing an information processing apparatus serving as a transmission source from which the first image is transmitted; transmitting a facsimile of the first image to the transmission destination represented by the transmission-destination-information via an external network; registering, in a transfer information storage unit, transfer information that associates, with each other, first-transmission-source-information where a transmission source is the transmission destination represented by the transmission-destination-information and transfer-destination-information-processing-apparatus-identifying-information where a transfer destination is the information processing apparatus represented by the transmission-source-information-processing-apparatus-identifying-information; receiving, via the external network, a facsimile of a second image and second-transmission-source-information representing a transmission source from which the second image is transmitted; and when the transmission source represented by the second-transmission-source-information matches the transmission source represented by the first-transmission-source-information, transmitting the second image via the internal network to the information processing apparatus represented by the transfer-destination-information-processing-apparatus-identifying-information that is associated with the first-transmission-source-information.

Exemplary embodiments of the present invention also provide a non-transitory computer-readable recording medium that contains a computer program for causing a computer to execute a process comprising: receiving, from any one of at least one information processing apparatus via an internal network, a first image, transmission-destination-information representing a transmission destination to which the first image is to be transmitted, and transmission-source-information-processing-apparatus-identifying-information representing an information processing apparatus serving as a transmission source from which the first image is transmitted; transmitting a facsimile of the first image to the transmission destination represented by the transmission-destination-information via an external network; registering, in a transfer information storage unit, transfer information that associates, with each other, first-transmission-source-information where a transmission source is the transmission destination represented by the transmission-destination-information and transfer-destination-information-processing-apparatus-identifying-information where a transfer destination is the information processing apparatus represented by the transmission-source-information-processing-apparatus-identifying-information; receiving, via the external network, a facsimile of a second image and second-transmission-source-information representing a transmission source from which the second image is transmitted; and when the transmission source represented by the second-transmission-source-information matches the transmission source represented by the first-transmission-source-information, transmitting the second image via the internal network to the information processing apparatus represented by the transfer-destination-information-processing-apparatus-identifying-information that is associated with the first-transmission-source-information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an exemplary configuration of a facsimile system according to an embodiment of the present invention;

FIG. 2 is a configuration diagram of an exemplary hardware configuration of a parent device according to the embodiment;

FIG. 3 is a configuration diagram of an exemplary hardware configuration of a child device according to the embodiment;

FIG. 4 is a block diagram of an exemplary functional configuration of the parent device according to the embodiment;

FIG. 5 is a diagram of exemplary facsimile request information according to the embodiment;

FIG. 6 is a table of an exemplary transfer list that is stored in a transfer information storage unit according to the embodiment;

FIG. 7 is a block diagram of an exemplary functional configuration of the child device according to the embodiment;

FIG. 8 is a diagram of an exemplary reception transfer cancellation screen according to the embodiment;

FIG. 9 is a diagram of an exemplary reception transfer registration screen according to the embodiment;

FIG. 10 is a flowchart of an exemplary registration process executed by the parent device according to the embodiment;

FIG. 11 is a flowchart of an exemplary transfer process executed by the parent device according to the embodiment;

FIG. 12 is a flowchart of an exemplary deletion process executed by the parent device according to the embodiment;

FIG. 13 is a block diagram of an exemplary functional configuration of a parent device according to modification 1 of the embodiment;

FIG. 14 is a table of an exemplary transfer list that is stored in a transfer information storage unit according to the modification 1;

FIG. 15 is a flowchart of an exemplary transfer process that is executed by the parent device according to the modification 1;

FIG. 16 is a block diagram of an exemplary functional configuration of a child device according to modification 2 of the embodiment;

FIG. 17 is a diagram of an exemplary transfer necessary/unnecessary setting screen according to the modification 2;

FIG. 18 is a block diagram of an exemplary functional configuration of the parent device according to the modification 2;

FIG. 19 is a flowchart of an exemplary registration process executed by the parent device according to the modification 2;

FIG. 20 is a block diagram of an exemplary functional configuration of a child device according to modification 3 of the embodiment;

FIG. 21 is a diagram of an exemplary reply necessary/unnecessary setting screen according to the modification 3;

FIG. 22 is a block diagram of an exemplary functional configuration of a parent device according to the modification 3;

FIG. 23 is a table of an exemplary transfer list that is stored in a transfer information storage unit according to the modification 3;

FIG. 24 is a flowchart of an exemplary registration process executed by the parent device according to the modification 3;

FIG. 25 is a flowchart of an exemplary transfer process executed by the parent device according to the modification 3;

FIG. 26 is a block diagram of an exemplary functional configuration of a parent device according to modification 4 of the embodiment;

FIG. 27 is a table of an exemplary transfer list that is stored in a transfer information storage unit according to the modification 4;

FIG. 28 is a flowchart of an exemplary transfer process that is executed by the parent device according to the modification 4;

FIG. 29 is a block diagram of an exemplary functional configuration of a parent device according to modification 5 of the embodiment;

FIG. 30 is a block diagram of an exemplary functional configuration of a child device according to the modification 5;

FIG. 31 is a diagram of an exemplary reply check screen according to the modification 5;

FIG. 32 is a flowchart of an exemplary transfer process executed by the parent device when a reception image is received according to the modification 5;

FIG. 33 is a table of an exemplary reply check list according to the modification 5;

FIG. 34 is a flowchart of an exemplary transfer process executed by the parent device when reply-result-information is received according to the modification 5;

FIG. 35 is a block diagram of an exemplary functional configuration of a parent device according to modification 6 of the embodiment;

FIG. 36 is a table of an exemplary transfer list stored in a transfer information storage unit according to the modification 6;

FIG. 37 is a flowchart of an exemplary transfer process executed by the parent device according to the modification 6;

FIG. 38 is a block diagram of an exemplary functional configuration of a parent device according to Modification 7 of the embodiment;

FIG. 39 is a table of an exemplary transfer list that is stored in a transfer information storage unit according to the modification 7;

FIG. 40 is a flowchart of an exemplary transfer process executed by the parent device according to the modification 7;

FIG. 41 is a block diagram of an exemplary functional configuration of a parent device according to modification 8 of the embodiment;

FIG. 42 is a table of an exemplary transfer list that is stored in a transfer information storage unit according to the modification 8;

FIG. 43 is a flowchart of an exemplary transfer process that is executed by the parent device according to the modification 8;

FIG. 44 is a block diagram of an exemplary functional configuration of a parent device according to modification 9 of the embodiment;

FIG. 45 is a block diagram of an exemplary functional configuration of a child device according to the modification 9;

FIG. 46 is a diagram of an exemplary print selection screen according to the modification 9;

FIG. 47 is a diagram of an exemplary list screen according to the modification 9;

FIG. 48 is a flowchart of an exemplary transfer process that is executed by the parent device according to the modification 9; and

FIG. 49 is a flowchart of an exemplary transfer process executed by the parent device when print-execution-information-processing-apparatus-information is received according to the modification 9.

### DETAILED DESCRIPTION OF THE PREFERRED EMBODIMENTS

With reference to the accompanying drawings, an embodiment of the facsimile apparatus, the image transmission method, and the computer-readable recording medium having the computer program according to the invention will be described in detail below.

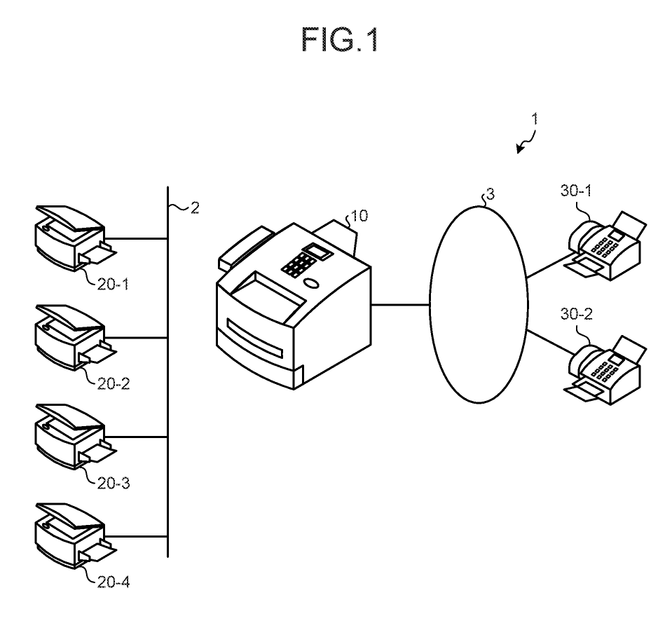

FIG. 1 is a schematic diagram of an exemplary configuration of a facsimile system 1 according to the embodiment. As shown in FIG. 1, the facsimile system 1 includes a parent device 10, child devices 20-1 to 20-4, and external facsimile apparatuses 30-1 and 30-2. The parent device 10 and the child devices 20-1 to 20-4 are connected via an internal network 2 and the parent device 10 and the external facsimile apparatuses 30-1 and 30-2 are connected via an external network 3.

In the following descriptions, the child devices 20-1 to 20-4 may be referred to simply as a child device 20 when it is unnecessary to distinguish the child devices 20-1 to 20-4 and the external facsimile apparatuses 30-1 and 30-2 may be referred to simply as an external facsimile apparatus 30 when it is unnecessary to distinguish the external facsimile apparatuses 30-1 and 30-2. FIG. 1 exemplifies the case where there are four child devices 20; however, the number of child devices 20 is not limited to this and any number of child devices may be used as long as there is at least one child device 20. Similarly, FIG. 1 exemplifies the case where there are two external facsimile apparatuses 30; however, the number of external facsimile apparatuses 30 is not limited to this and any number of external facsimile apparatuses 30 may be used as long as there is at least one external facsimile apparatus 30.

The parent device 10 is a facsimile apparatus that is connected to the external network 3. It suffices if the facsimile apparatus has at least a facsimile function, and the facsimile apparatus is, for example, an apparatus whose main function is the facsimile function, a telephone set that has the facsimile function, or a multifunction peripheral (MFP) having the facsimile function. According to the embodiment, a case will be exemplified where the parent device 10 is an apparatus whose main function is the facsimile function; however, the parent device 10 is not limited to this.

The child device 20 is an information processing apparatus that is connected to the internal network 2 to which the parent device 10 is connected. The child device 20 is, for example, an image processing apparatus, such as a MFP that has an image reading function (scanner function) and a printing function, a personal computer (PC), a tablet terminal, or a smartphone. For the embodiment, a case will be exemplified where the child device 20 is an MFP having the image reading function and the printing function; however, the child device is not limited to this.

The internal network 2 is a private network, such as a local area network (LAN). The external network 3 is a public network, such as a public line network or the Internet. According to the embodiment, a case will be exemplified where the external network 3 is a public line network; however, the external network 3 is not limited to this.

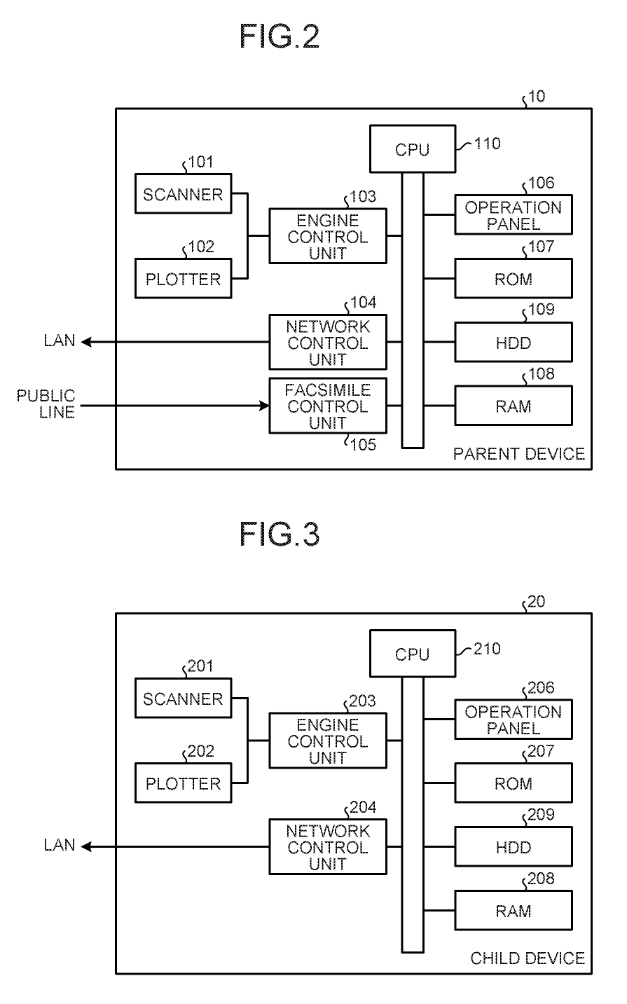

FIG. 2 is a configuration diagram of an exemplary hardware configuration of the parent device 10 according to the embodiment. As shown in FIG. 2, the parent device 10 includes a scanner 101, a plotter 102, an engine control unit 103, a network control unit 104, a facsimile control unit 105, an operation panel 106, a read only memory (ROM) 107, a random access memory (RAM) 108, a hard disk drive (HDD) 109, and a central processing unit (CPU) 110. The hardware configuration of the parent device 10 shown in FIG. 2 is an example only and the hardware configuration of the parent device 10 is not limited to this.

The scanner 101 electrically reads an original that is placed on an original table and generates an image. The plotter 102 prints out the image. The engine control unit 103 controls the scanner 101 to cause the scanner 101 to read the original and controls the plotter 102 to cause the plotter 102 to print out the image. The network control unit 104 controls communications via the internal network 2. The facsimile control unit 105 controls communications via the external network 3.

The operation panel 106 includes a liquid crystal display (LCD) for displaying a screen, a light emitting diode (LED) representing the state, a buzzer, a hardware key, and a touch panel, displays various types of information on the LCD, and accepts inputs of various types of information from the hardware key and the touch panel.

The ROM 107 stores a program that is executed by the CPU 110, etc. The RAM 108 is used as a work area of the CPU 110. The HDD 109 stores various types of data used by the CPU 110. The CPU 110 executes, in the RAM 108, the program stored in the ROM 107 to control the engine control unit 103, the network control unit 104, the facsimile control unit 105, the operation panel 106, etc., that are connected via a bus.

FIG. 3 is a configuration diagram of an exemplary hardware configuration of the child device 20 according to the embodiment. As shown in FIG. 3, the child device 20 includes a scanner 201, a plotter 202, an engine control unit 203, a network control unit 204, an operation panel 206, a ROM 207, a RAM 208, an HDD 209, and a CPU 210. The hardware configuration of the child device 20 shown in FIG. 3 is an example only and the hardware configuration of the child device 20 is not limited to this.

The scanner 201 electrically reads an original placed on an original table and generates an image. The plotter 202 prints out the image. The engine control unit 203 controls the scanner 201 to cause the scanner 201 to read the original and control the plotter 202 to cause the plotter to print out the image. The network control unit 204 controls communications via the internal network 2.

The operation panel 206 includes an LCD for displaying a screen, an LED representing the state, a buzzer, a hardware key, and a touch panel. The operation panel 206 displays various types of information on the LCD and accepts inputs of various types of information from the hardware key or the touch panel.

The ROM 207 stores a program that is executed by the CPU 210, etc. The RAM 208 is used as a work area of the CPU 210. The HDD 209 stores various types of data used by the CPU 210. The CPU 210 executes, in the RAM 208, the program stored in the ROM 207 to control the engine control unit 203, the network control unit 204, the operation panel 206, etc., that are connected via a bus.

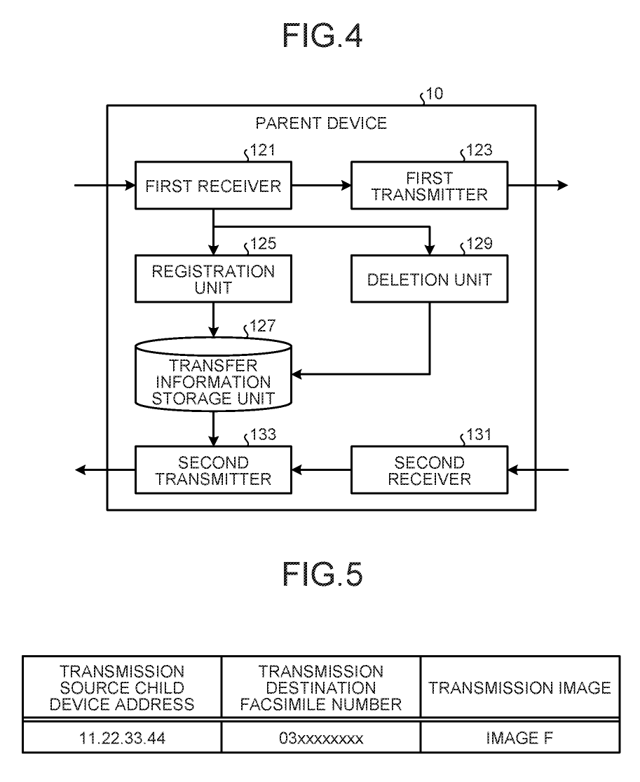

FIG. 4 is a block diagram of an exemplary functional configuration of the parent device 10 according to the embodiment. As shown in FIG. 4, the parent device 10 includes a first receiver 121, a first transmitter 123, a registration unit 125, a transfer information storage unit 127, a deletion unit 129, a second receiver 131, and a second transmitter 133.

The first receiver 121 and the second transmitter 133 can be implemented by using, for example, the network control unit 104, the RAM 108, and the CPU 110. The first transmitter 123 and the second receiver 131 can be implemented by using, for example, the facsimile control unit 105, the RAM 108, and the CPU 110. The registration unit 125 and the deletion unit 129 can be implemented by using, for example, the RAM 108 and the CPU 110. The transfer information storage unit 127 can be implemented by using, for example, the HDD 109.

The first receiver 121 receives, from an one of the child devices 20-1 to 20-4 and via the internal network, facsimile request information that associates, with one another, a first image, transmission-destination-information representing a transmission destination to which the first image is to be transmitted, and transmission-source-information-processing-apparatus-identifying-information representing a child device 20 serving as a transmission source from which the first image is transmitted. The first image is, for example, a transmission image to be transmitted, the transmission-destination-information is, for example, the facsimile number of an external facsimile apparatus 30 serving as the transmission destination, and the transmission-source-information-processing-apparatus-identifying-information is, for example, the IP address of the child device 20 serving as the transmission source.

FIG. 5 is a diagram of exemplary facsimile request information according to the embodiment. According to the example shown in FIG. 5, the transmission source child device address (the transmission-source-information processing-apparatus-identifying-information) is the IP address of the child device 20 serving as the transmission source, the transmission destination facsimile number (transmission-destination-information) is the facsimile number of the external facsimile apparatus 30 serving as the transmission destination, and the transmission image (first image) is an image F.

From any of the child devices 20-1 to 20-4, the first receiver 121 further receives deletion information, or registration information, representing the child device 20 and the transmission source. The deletion information is information for deleting transfer information, which will be described below. The deletion information is, for example, information representing a set of a flag representing deletion, the IP address of the child device 20 that transmits the deletion information and that serves as a transfer destination to which a reception image is to be transferred, and a facsimile number of the external facsimile apparatus 30 from which a reception image is transmitted. The registration information is information for registering transfer information, which will be described below. The registration information is, for example, information representing a set of a flag representing registration, the IP address of the child device 20 that transmits the registration information and to which the reception image is to be transferred, and the facsimile number of the external facsimile apparatus 30 from which the reception image is transmitted.

The first transmitter 123 transmits, via the external network 3, a facsimile of the first image contained in the facsimile request information received by the first receiver 121 to the transmission destination represented by the transmission-destination-information contained in the facsimile request information. For example, the transmission-destination-information is “03xxxxxxxx” according to the facsimile request information shown in FIG. 5 and thus the first transmitter 123 transmits the image F to the external facsimile apparatus 30 represented by “03xxxxxxxx”.

The registration unit 125 registers, in the transfer information storage unit 127, the transfer information that associates first-transmission-source-information where the transmission source is the transmission destination represented by the transmission-destination-information contained in the facsimile request information received by the first receiver 121 with transfer-destination-information-processing-apparatus-identifying-information where the transfer destination is the information processing apparatus represented by the transmission-source-information-processing-apparatus-identifying-information contained in the facsimile request information.

In short, when the transmission-destination-information is the facsimile number of an external facsimile apparatus 30 serving as the transmission destination, the first-transmission-source-information is that facsimile number; and, when the transmission-source-information-processing-apparatus-identifying-information is the IP address of a child device 20 serving as the transmission source, the transfer-destination-information-processing-apparatus-identifying-information is that IP address.

Each time the first transmitter 123 transmits a facsimile, the registration unit 125 registers, in the transfer information storage unit 127, transfer information based on facsimile request information received by the first receiver 121. The registration unit 125 may cache the facsimile request information received by the first receiver 121 and collectively register multiple sets of transfer information in the transfer information storage unit 127.

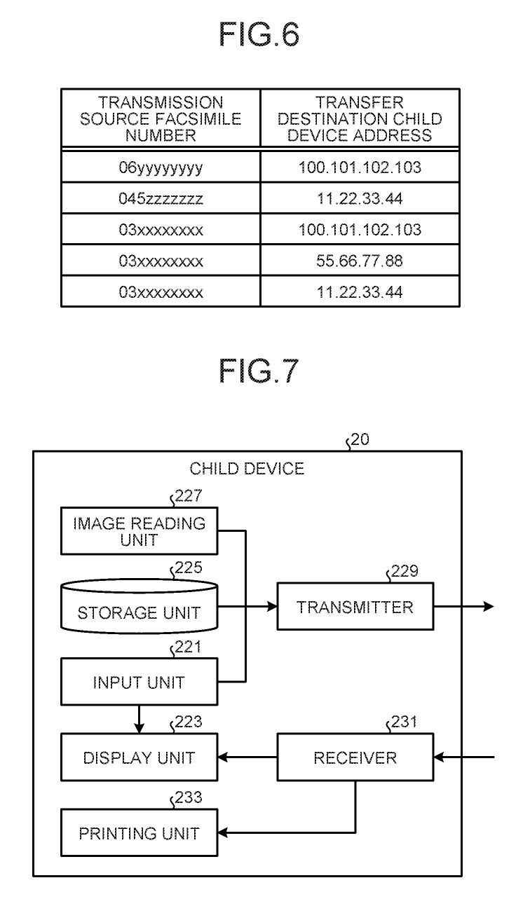

FIG. 6 is a table of an exemplary transfer list that is stored in the transfer information storage unit 127 according to the embodiment. The transfer list consists of five sets of transfer information. According to the example shown in FIG. 6, the transmission source facsimile numbers (first-transmission-source-information) are the facsimile numbers of external facsimile apparatuses 30 serving as the transmission sources and the transfer destination child device addresses (the transfer-destination-information-processing-apparatus-identifying-information) are the IP addresses of child devices 20 serving as transfer destinations. According to the example shown in FIG. 6, the transfer information in the fifth row is registered according to the facsimile request information shown in FIG. 5.

The deletion unit 129 deletes, from the transfer information storage unit 127, the transfer information that contains the transfer-destination-information-processing-apparatus-identifying-information representing the child device 20 represented by the deletion information received by the first receiver 121 and the first-transmission-source-information representing the transmission source represented by the deletion information.

For example, it is assumed that the deletion information represents “11.22.33.44” as the IP address of the child device 20 (child device 20 serving as a transfer destination to which the reception image is to be transferred) serving as the transmission source and represents “03xxxxxxxx” as the facsimile number of the external facsimile apparatus 30 serving as the transmission source from which the reception image is transmitted, and the transfer information registered in the transfer information storage unit 127 is as shown in FIG. 6. In this case, the deletion unit 129 deletes the transfer information in the fifth row from the example shown in FIG. 6.

The registration unit 125 registers, in the transfer information storage unit 127, the transfer information containing the transfer-destination-information-processing-apparatus-identifying-information representing the child device 20 represented by the registration information received by the first receiver 121 and the first-transmission-source-information representing the transmission source represented by the registration information.

For example, it is assumed that the transfer information registered in the transfer information storage unit 127 is one obtained by deleting the transfer information in the fifth row from that shown in FIG. 6 and the registration information represents “11.22.33.44” as the IP address of the child device 20 (child device 20 serving as a transfer destination to which the reception image is to be transferred) and represents “03xxxxxxxx” as the facsimile number of the external facsimile apparatus 30 serving as the transmission source from which the reception image is transmitted. In this case, the registration unit 125 registers the transfer information in the fifth row in the example shown in FIG. 6.

According to the embodiment, in accordance with facsimile transmission from the child device 20 to the outside, the transfer information that is automatically registered by the registration unit 125 can be manually deleted/registered via the child device 20. For this reason, according to the embodiment, it is possible to additionally register transfer information that is deleted when the automatically registered transfer information is unnecessary or that is erroneously deleted or additionally register transfer information when a reply facsimile is required to be received by a child device 20 different from the child device 20 that transmits the facsimile.

The second receiver 131 receives, from an external facsimile apparatus 30 via the external network 3, a facsimile of a second image and second-transmission-source-information representing a transmission source from which the second image is transmitted. The second image is, for example, a reception image to be received and the second-transmission-source-information is, for example, the facsimile number of the external facsimile apparatus 30 serving as the transmission source.

When the transmission source represented by the second-transmission-source-information received by the second receiver 131 matches the transmission source represented by the first-transmission-source-information contained in the transfer information registered in the transfer information storage unit 127, the second transmitter 133 transmits, via the internal network 2, the second image received by the second receiver 131 to the child device 20 represented by the transfer-destination-information-processing-apparatus-identifying-information associated with the first-transmission-source-information.

For example, it is assumed that the second-transmission-source-information received by the second receiver 131 is “045zzzzzzz” and the transfer information registered in the transfer information storage unit 127 is as shown in FIG. 6. In this case, the second transmitter 133 transmits the second image to the child device 20 represented by “11.22.33.44” that is the transfer destination child device address contained in the transfer information in the second row where the transmission source facsimile number is “045zzzzzzz”.

When there are multiple sets of first-transmission-source-information representing the transmission source that matches the transmission source represented by the second-transmission-source-information in the transfer information registered in the transfer information storage unit 127, the second transmitter 133 transmits the second image via the internal network 2 to the child devices 20 represented by the sets of transfer-destination-information-processing-apparatus-identifying-information associated respectively with the sets of first-transmission-source-information. Accordingly, the second image can be correctly transferred to the child devices 20 that may require receiving the second image.

For example, it is assumed that the second-transmission-source-information received by the second receiver 131 is “03xxxxxxxx” and the transfer information registered in the transfer information storage unit 127 is as shown in FIG. 6. In this case, the second transmitter 133 transmits the second image to the child devices 20 respectively represented by “100.101.102.103”, “55.66.77.88” and “11.22.33.44” that are the transfer destination child device addresses contained in the sets of transfer information in the third to fifth rows where the transmission source facsimile number is “03xxxxxxxx” in the example shown in FIG. 6.

When there is no first-transmission-source-information representing the transmission source that matches the transmission source represented by the second-transmission-source-information in the transfer information that is registered in the transfer information storage unit 127, the second image may be transmitted to a predetermined (default) child device 20 or the parent device 10 may print the second image.

FIG. 7 is a block diagram of an exemplary functional configuration of the child device 20 according to the embodiment. As shown in FIG. 7, the child device 20 includes an input unit 221, a display unit 223, a storage unit 225, an image reading unit 227, a transmitter 229, a receiver 231, and a printing unit 233.

The input unit 221 and the display unit 223 can be implemented by using, for example, the operation panel 206, the RAM 208 and the CPU 210. The storage unit 225 can be implemented by using, for example, the HDD 209. The image reading unit 227 can be implemented by using, for example, the scanner 201, the engine control unit 203, the RAM 208, and the CPU 210. The transmitter 229 and the receiver 231 can be implemented by using, for example, the network control unit 204, the RAM 208, and the CPU 210. The printing unit 233 can be implemented by using, for example, the plotter 202, the engine control unit 203, the RAM 208, and the CPU 210.

The input unit 221 causes the display unit 223 to display a screen for inputting facsimile request information and inputs transmission destination information according to a user operation and the image reading unit 227 reads an original and generates a first image. The storage unit 225 stores the transmission-source-information-processing-apparatus-identifying-information representing the child devices 20. The transmitter 229 acquires the first image generated by the image reading unit 227, the transmission-destination-information input by the input unit 221, and the transmission-source-information-processing-apparatus-identifying-information that is stored in the storage unit 225 and transmits facsimile request information that associates the first image, the transmission-source-information, and the transmission-source-information-processing-apparatus-identifying-information to the parent device 10 via the internal network 2.

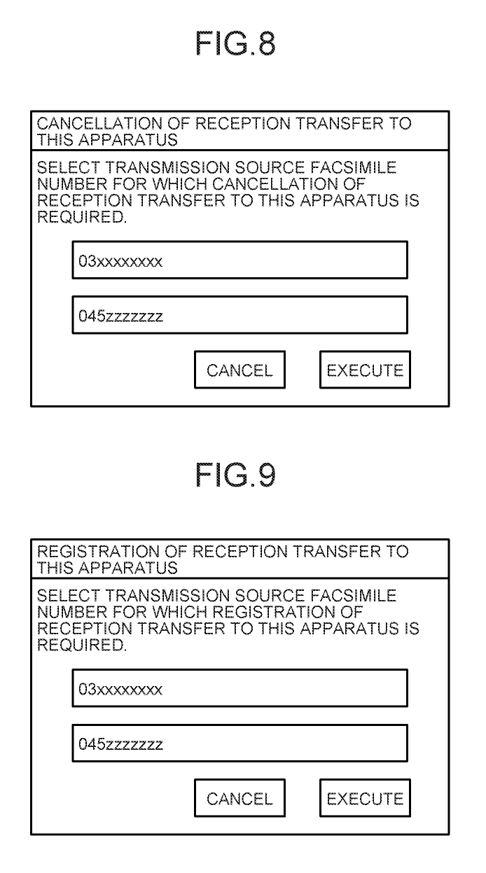

The input unit 221 displays a reception transfer cancellation screen like that shown in FIG. 8 on the display unit 223 and, according to a user operation, inputs (selects) a facsimile number serving as a transmission source from which the second image (reception image) is transmitted. The transmitter 229 acquires the transmission destination facsimile number that is input by the input unit 221 and the transmission-source-information-processing-apparatus-identifying-information that is stored in the storage unit 225 and transmits deletion information that associates the transmission destination facsimile number with the transmission-source-information-processing-apparatus-identifying-information to the parent device 10 via the internal network 2.

The input unit 221 displays a reception transfer registration screen like that shown in FIG. 9 on the display unit 223 and, according to a user operation, inputs (selects) the facsimile number of the transmission source from which the second image (reception image) is transmitted. The transmitter 229 acquires the transmission destination facsimile number input by the input unit 221 and the transmission-source-information-processing-apparatus-identifying-information stored in the storage unit 225 and transmits registration information that associates the transmission destination facsimile number with the transmission-source-information-processing-apparatus-identifying-information to the parent device 10 via the internal network 2.

The receiver 231 receives the second image from the parent device 10 via the internal network 2. The printing unit 233 prints out the second image received by the receiver 231. The display unit 223 may display and output the second image received by the receiver 231.

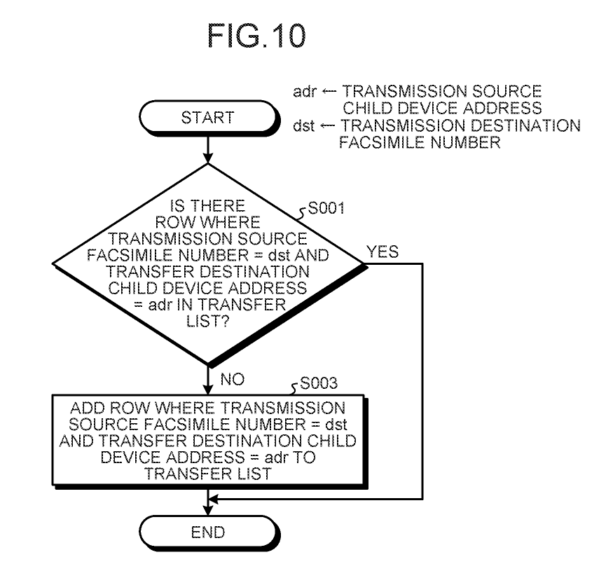

FIG. 10 is a flowchart of an exemplary registration process executed by the parent device 10 according to the embodiment.

The registration unit 125 checks whether, in the transfer list stored in the transfer information storage unit 127, there is a row of transfer information where the transmission source facsimile number is the transmission destination facsimile number (dst) contained in a facsimile request information received by the first receiver 121 and the transfer destination child device address is the transmission source child device address (adr) contained in the facsimile request information (step S001).

When it is NO at step S001, the registration unit 125 additionally registers, in the transfer list, a row of transfer information where the transmission source facsimile number is the transmission destination facsimile number (dst) contained in the facsimile request information and the transfer destination child device address is the transmission source child device address (adr) contained in the facsimile request information (step S003).

On the other hand, when it is YES at step S001, the processing at step S003 is not performed.

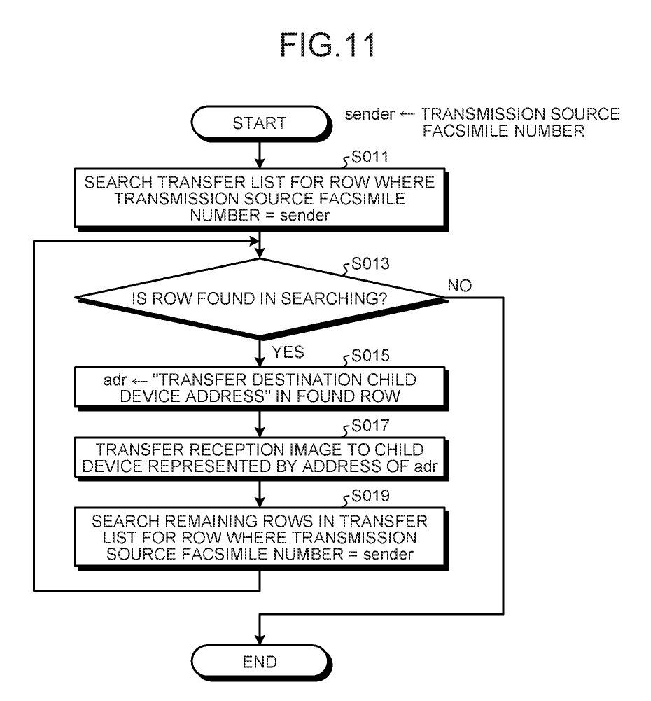

FIG. 11 is a flowchart of an exemplary transfer process executed by the parent device 10 according to the embodiment.

First, the second transmitter 133 searches the transfer list stored in the transfer information storage unit 127 for a row of transfer information where the transmission source facsimile number matches the transmission source facsimile number (sender) received by the second receiver 131 (step S011).

When a row of transfer information where the transmission source facsimile number matches the transmission source facsimile number (sender) received by the second receiver 131 is found (YES at step S013), the second transmitter 133 sets the transfer destination child device address in the found row of transfer information for the transfer destination (adr) to which the reception image received by the second receiver 131 is to be transferred (step S015) and transfers the reception image to the child device 20 represented by the transfer destination child device address that is set for the transfer destination (adr) (step S017).

The second transmitter 133 then searches the rows of transfer information that have not been searched in the transfer list stored in the transfer information storage unit 127 for a row of transfer information where the transmission source facsimile number matches the transmission source facsimile number (sender) received by the second receiver 131 (step S019) and the process goes back to step S103.

When it is YES at step S103, the process goes to step S015. When it is NO at step S013, the process ends.

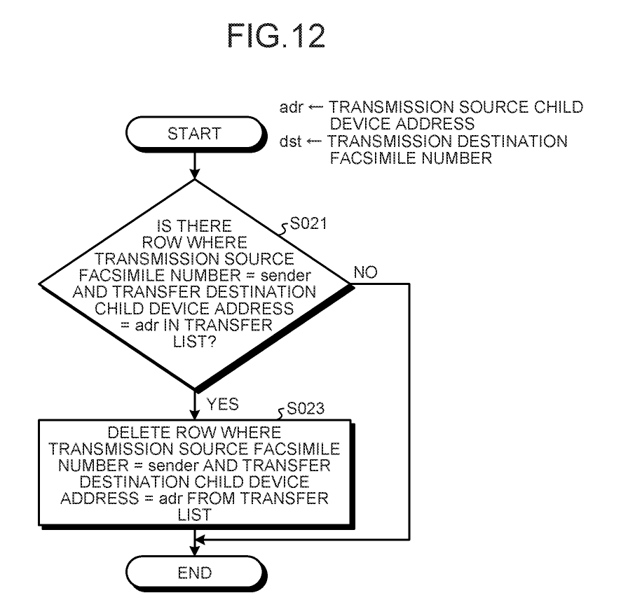

FIG. 12 is a flowchart of an exemplary deletion process that is executed by the parent device 10 according to the embodiment.

First, the deletion unit 129 searches the transfer list stored in the transfer information storage unit 127 to check whether there is a row of transfer information where the transmission source facsimile number is the transmission source facsimile number (sender) contained in deletion information received by the first receiver 121 and the transfer destination child device address is the transmission source child device address contained in the deletion information (step S021).

When it is YES at step S021, the deletion unit 129 deletes the row of transfer information searched for from the transfer list (step S023).

On the other hand, when it is NO at step S021, the processing at step S023 is not performed.

As described above, according to the embodiment, upon receiving the facsimile request information from the child device 20, the parent device 10 automatically registers, in the transfer information storage unit 127, the transfer information that associates the first-transmission-source-information where the transmission source is the transmission destination represented by the transmission-destination-information contained in the facsimile request information with the transfer-destination-information-processing-apparatus-identifying-information where the transfer destination is the information processing apparatus represented by the transmission-source-information-processing-apparatus-identifying-information contained in the facsimile request information.

As described above, according to the embodiment, the parent device 10 automatically registers the transfer information in accordance with transmission of a facsimile from a child device 20 to the outside, which enhances convenience in transferring a facsimile transmitted from the transmission source to an intended child device.

Modification 1

For modification 1 of the embodiment, an example will be described where, when there are multiple child devices to which a second image (reception image) is to be transferred, a child device to which the second image is to be transferred is determined according to the similarity with a first image (transmission image). Differences from the embodiment will be mainly described below and components having the same functions as those of the embodiment are denoted with the same names and reference numerals as those of the embodiment to omit descriptions of the components.

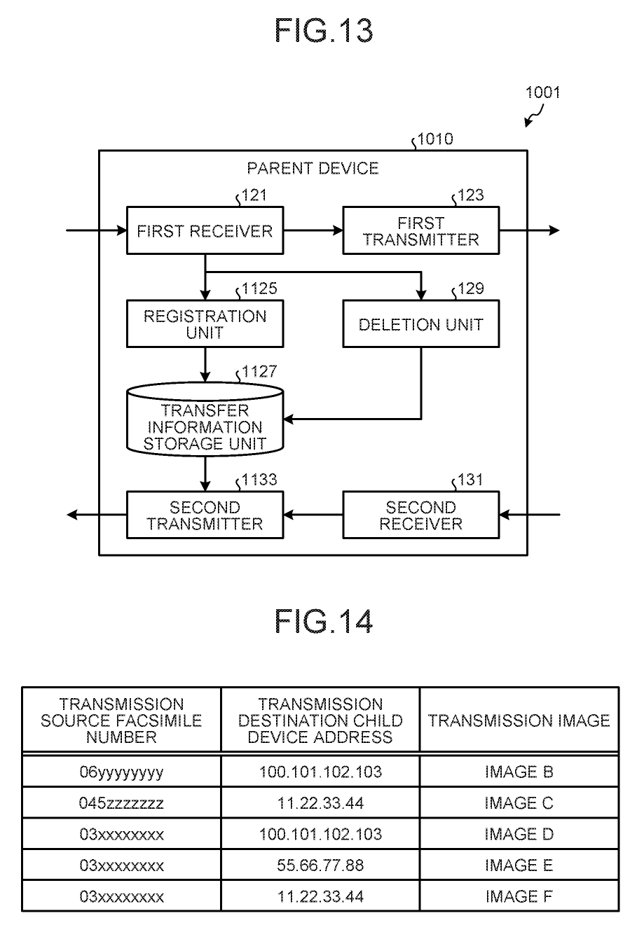

FIG. 13 is a block diagram of an exemplary functional configuration of a parent device 1010 of a facsimile system 1001 according to modification 1 of the embodiment. As shown in FIG. 13, the parent device 1010 of the modification 1 has a difference from the parent device 10 of the embodiment in a registration unit 1125, a transfer information storage unit 1127, and a second transmitter 1133.

Each time the first transmitter 123 transmits a facsimile, the registration unit 1125 registers, in the transfer information storage unit 1127, transfer information that associates, with one another, first-transmission-source-information where the transmission source is the transmission destination represented by the transmission-destination-information contained in facsimile request information received by the first receiver 121, transfer destination information processing apparatus identifying information where the transmission destination is the information processing apparatus represented by the transmission-source-information-processing-apparatus-identifying-information contained in the facsimile request information, and the first image contained in the facsimile request information.

FIG. 14 is a table of an exemplary transfer list stored in the transfer information storage unit 1127 of the modification 1. According to the example shown in FIG. 14, transmission source facsimile numbers (first-transmission-source-information) are the facsimile numbers of the external facsimile apparatuses 30 serving as the transmission sources and transfer destination child device addresses (transfer-destination-information-processing-apparatus-identifying-information) are the IP addresses of child devices 20 serving as transfer destinations, and transmission images are the first images contained in sets of facsimile request information. According to the example shown in FIG. 14, the transfer information of the fifth row is registered according to the facsimile request information shown in FIG. 5.

When, in the transfer information registered in the transfer information storage unit 1127, there are multiple sets of first-transmission-source-information each representing the transmission source that matches the transmission source represented by the second-transmission-source-information, the second transmitter 1133 transmits the second image via the internal network 2 to the child device 20 represented by the transfer destination information processing apparatus identifying information associated with the first image the most similar to the second image from among first images respectively associated with the sets of first-transmission-source-information.

For example, it is assumed that the second transmission-source-information received by the second receiver 131 is “03xxxxxxxx”, the second image (reception image) is “an image F′” obtained by adding a handwritten comment to the image F, and the transfer information registered in the transfer information storage unit 1127 is as shown in FIG. 14. In this case, the second transmitter 1133 calculates the similarity between “IMAGE F′” and each of “IMAGE D”, “IMAGE E” and “IMAGE F” that are transmission images (first images) contained in the sets of transfer information in the third to fifth rows where the transmission source facsimile number is “03xxxxxxxx”. For the method of calculating similarity, a known method, such as pattern matching, may be used. It is assumed here that the similarity between “IMAGE F” and “IMAGE F′” is the highest. For this reason, the second transmitter 1133 transmits “IMAGE F′” to the child device 20 represented by “11.22.33.44” that is the transfer destination child device address associated with “IMAGE F” in the example shown in FIG. 14.

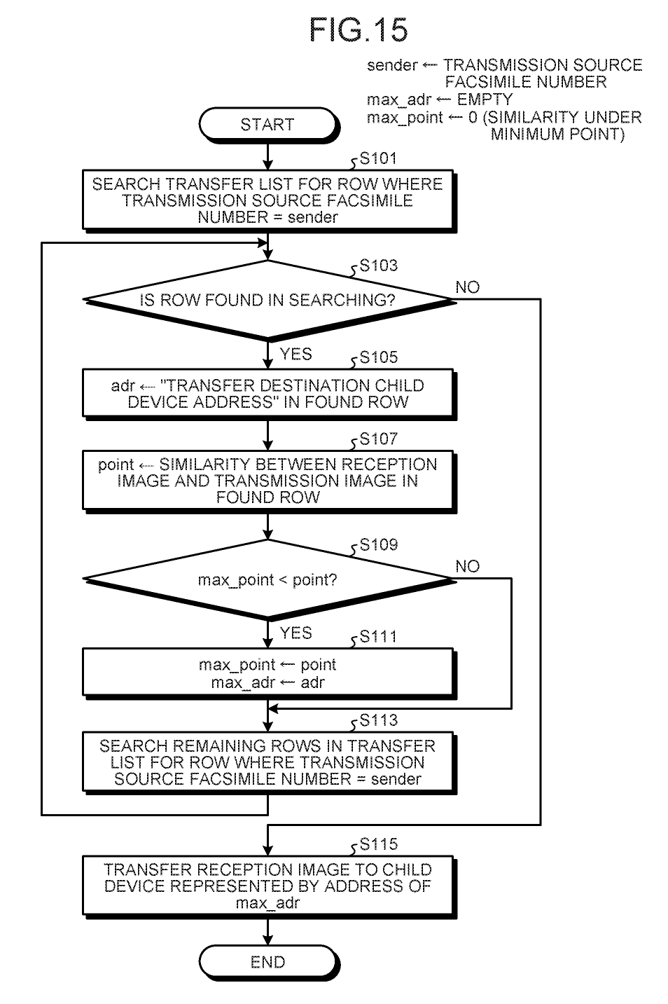

FIG. 15 is a flowchart of an exemplary transfer process executed by the parent device 1010 according to the modification 1.

First, the second transmitter 1133 searches the transfer list stored in the transfer information storage unit 1127 for a row of transfer information where the transmission source facsimile number matches the transmission source facsimile number (sender) received by the second receiver 131 (step S101).

When a row of transfer information where the transmission source facsimile number matches the transmission source facsimile number (sender) received by the second receiver 131 is found (YES at step S103), the second transmitter 1133 sets the transfer destination child device address in the found row of transfer information for a candidate (adr) of transfer destination to which a reception image received by the second receiver 131 is to be transferred (step S105) and calculates the similarity (point) between the reception image and the transmission image in the found row of transfer information (step S107).

When the calculated similarity (point) is larger than the maximum similarity (max_point, initial value of 0) (YES at step S109), the calculated similarity (point) is set for the maximum similarity (max_point) and sets the transfer destination candidate (adr) for the transfer destination (max_adr) (step S111). When it is NO at step S109, the processing at step S111 is not performed.

The second transmitter 1133 then searches the rows of transfer information that have not been searched in the transfer list stored in the transfer information storage unit 1127 for a row of transfer information where the transmission source facsimile number matches the transmission source facsimile number (sender) received by the second receiver 131 (step S113) and the process goes back to step S103.

When it is YES at step S103, the process goes to step S105. When it is NO at step S103, the reception image is transferred to the child device 20 represented by the transfer destination child device address that is set for the transfer destination (max_adr) (step S115).

As described above, according to the modification 1, when, in the transfer information, there are multiple sets of first-transmission-source-information each representing the transmission source that matches the transmission source represented by the second-transmission-source-information, the parent device 1010 determines that the transfer destination is the child device 20 represented by the transfer-destination-information-processing-apparatus-identifying-information associated with the first image being the most similar to the second image among the first images associated respectively with the sets of first-transmission-source-information.

Because a facsimile reply tends to be made by adding, for example, a comment to a transmitted facsimile, the reception image tends to be similar to the transmission image. For this reason, according to the modification 1, the parent device 1010 is able to transfer the reception image to an appropriate child device 20.

Modification 2

For modification 2 of the embodiment, an example will be described where it is specified, in a parent device, whether a child device receives a facsimile that is transmitted from a transmission destination. Differences from the embodiment will be mainly described below and components having the same functions as those of the embodiment are denoted with the same names and reference numerals as those of the embodiment to omit descriptions of the components.

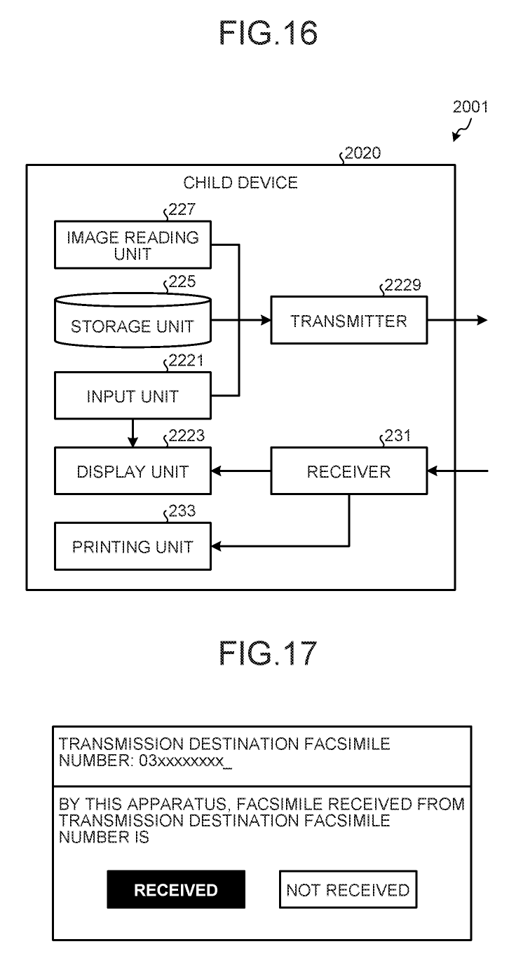

FIG. 16 is a block diagram of an exemplary functional configuration of a child device 2020 of a facsimile system 2001 according to the modification 2. As shown in FIG. 16, the child device 2020 of the modification 2 has a difference from the child device 20 of the embodiment in an input unit 2221, a display unit 2223 and a transmitter 2229.

The input unit 2221 causes the display unit 2223 to display a screen for inputting facsimile request information, inputs transmission destination information according to a user operation, and causes the display unit 2223 to display a transfer necessary/unnecessary setting screen like that shown in FIG. 17, and, according to a user operation, inputs transfer-necessary/unnecessary-information representing whether it is necessary or unnecessary to transfer (whether to receive or not receive) a facsimile (second image) from the transmission destination represented by the input-transmission-destination-information.

The transmitter 2229 acquires a first image generated by the image reading unit 227, the transmission-destination-information and the transfer-necessary/unnecessary-information that are input by the input unit 2221, and transmission-source-information-processing-apparatus-identifying-information stored in the storage unit 225, and transmits facsimile request information that associates the first image, the transmission-destination-information, the transfer-necessary/unnecessary-information, and the transmission-source-information-processing-apparatus-identifying-information to a parent device 2010 via the internal network 2.

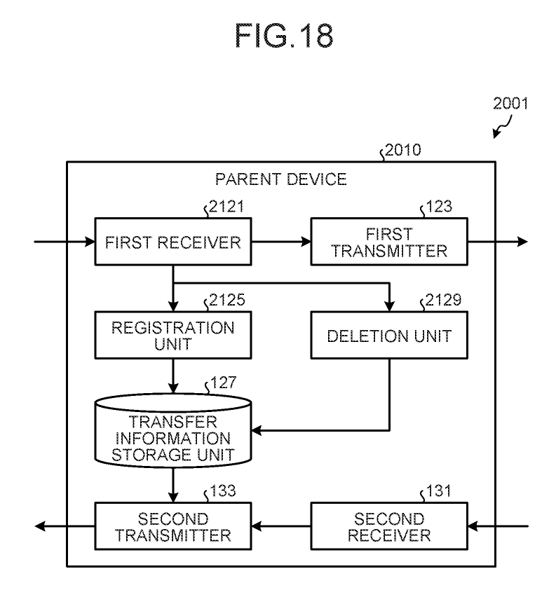

FIG. 18 is a block diagram of an exemplary functional configuration of the parent device 2010 according to the modification 2. As shown in FIG. 18, the parent device 2010 according to the modification 2 has a difference from the parent device 10 of the embodiment in a first receiver 2121, a registration unit 2125, and a deletion unit 2129.

The first receiver 2121 receives, from any one of child devices 2020 via the internal network 2, facsimile request information that associates a first image, transmission-destination-information representing a transmission destination to which the first image is to be transmitted, transmission-source-information-processing-apparatus-identifying-information representing the child device 20 serving as the transmission source from which the first image is transmitted, and transfer-necessary/unnecessary-information with each other. The transfer-necessary/unnecessary-information represents whether to transfer a second image that is transmitted from the transmission destination to which the first image is to be transmitted.

When the transfer-necessary/unnecessary-information contained in the facsimile request information received by the first receiver 121 represents that the transfer is necessary, the registration unit 2125 registers, in the transfer information storage unit 127, transfer information that associates, with each other, first-transmission-source-information where the transmission source is the transmission destination represented by the transmission destination information contained in the facsimile request information and transfer-destination-information-processing-apparatus-identifying-information where the transfer destination is the information processing apparatus represented by the transmission-source-information-processing-apparatus-identifying-information contained in the facsimile request information. When the transfer-necessary/unnecessary-information represents that the transfer is unnecessary, the registration unit 2125 does not register the transfer information in the transfer information storage unit 127.

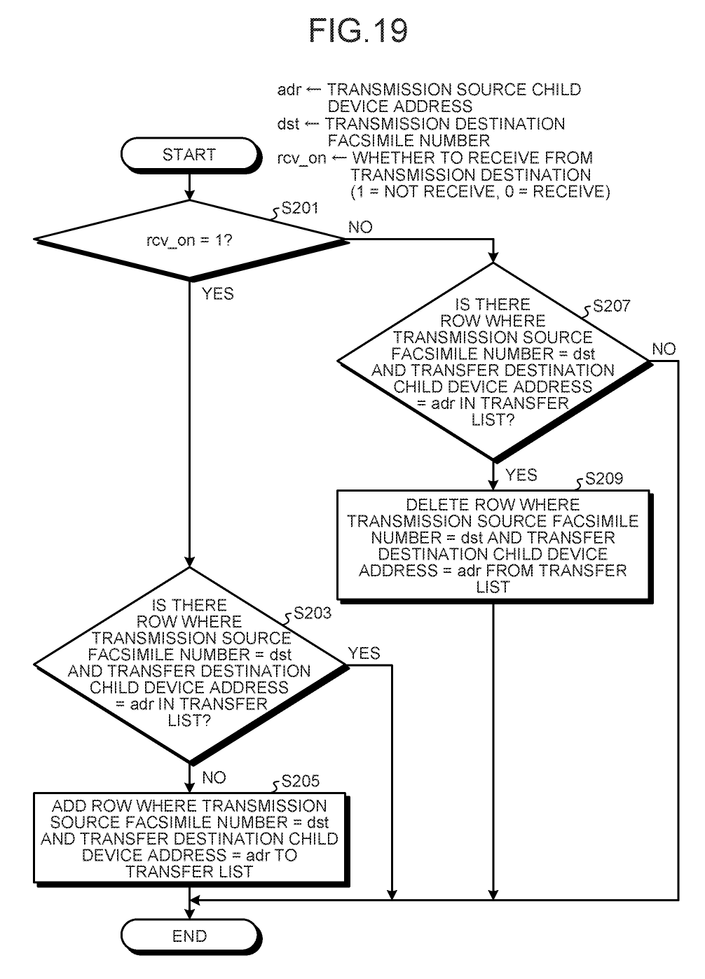

FIG. 19 is a flowchart of an exemplary registration process executed by the parent device 2010 according to the modification 2.

When transfer-necessary/unnecessary-information (rcv_on) contained in facsimile request information received by the first receiver 2121 represents that the transfer is necessary (1) (YES at step S201), the registration unit 2125 checks whether, in the transfer list stored in the transfer information storage unit 127, there is a row of transfer information where the transmission source facsimile number is the transmission destination facsimile number (dst) contained in the facsimile request information and the transfer destination child device address is the transmission source child device address (adr) contained in the facsimile request information (step S203).

When it is NO at step S203, the registration unit 2125 additionally registers, in the transfer list, the row of transfer information where the transmission source facsimile number is the transmission destination facsimile number (dst) contained in the facsimile request information and the transfer destination child device address is the transmission source child device address (adr) contained in the facsimile request information (step S205). When it is YES at step S203, the processing at step S205 is not performed.

On the other hand, when the transfer-necessary/unnecessary-information (rcv_on) contained in the facsimile request information received by the first receiver 2121 represents that the transfer is unnecessary (0) (NO at step S201), the deletion unit 2129 searches whether a row transfer information is presented in the transfer list stored in the transfer information storage unit 127 (step S207). The row transfer information is information where the transmission source facsimile number is the transmission destination facsimile number (dst) contained in the facsimile request information and the transfer destination child device address is the transmission source child device address (adr) contained in the facsimile request information.

When it is YES at step S207, the deletion unit 2129 deletes the row of transfer information that is searched for in the transfer list (step S209). When it is NO at step S207, the processing at step S209 is not performed.

As described above, according to the modification 2, because it is possible to specify, in the parent device 2010, whether the child device 2020 receives a facsimile transmitted from the transmission destination, the flexibility on whether the transfer to the child device 2020 is necessary or unnecessary can be increased.

Modification 3

For modification 3 of the embodiment, an example will be described where it is specified, in a parent device, whether a child device receives a reply facsimile to a transmission facsimile from a transmission destination to which the transmission facsimile is to be transmitted. Differences from the embodiment will be mainly described below and components having the same functions as those of the embodiment are denoted with the same names and reference numerals as those of the embodiment to omit descriptions of the components.

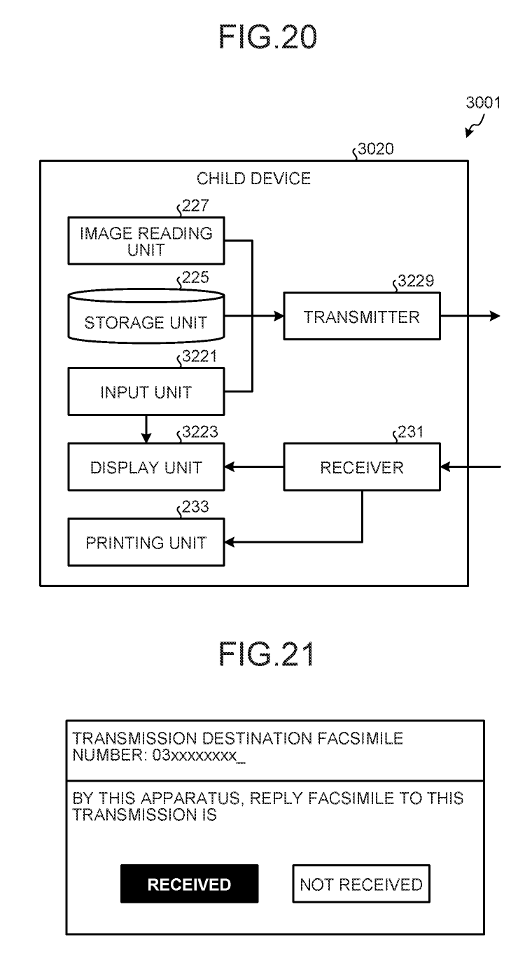

FIG. 20 is a block diagram of an exemplary functional configuration of a child device 3020 of a facsimile system 3001 according to the modification 3. As shown in FIG. 20, the child device 3020 according to the modification 3 has a difference from the child device 20 of the embodiment in an input unit 3221, a display unit 3223, and a transmitter 3229.

The input unit 3221 causes the display unit 3223 to display a screen for inputting facsimile request information, inputs transmission-destination-information according to a user operation and causes the display unit 3223 to display reply necessary/unnecessary setting screen like that shown in FIG. 21, and, according to a user operation, inputs reply-necessary/unnecessary-information representing whether it is necessary or unnecessary to transfer (whether to receive or not receive) a reply facsimile (second image) to a transmission facsimile (first image) transmitted to the transmission destination represented by the input-transmission-destination-information.

The transmitter 3229 acquires a first image that is generated by the image reading unit 227, the transmission-destination-information and the reply-necessary/unnecessary-information that are input from the input unit 3221, and transmission-source-information-processing-apparatus-identifying-information that is stored in the storage unit 225 and transmits, to a parent device 3010 via the internal network 2, facsimile request information that associates date information representing the transmission date with the first image, the transmission-destination-information, the reply-necessary/unnecessary-information, and the transmission-source-information-processing-apparatus-identifying-information.

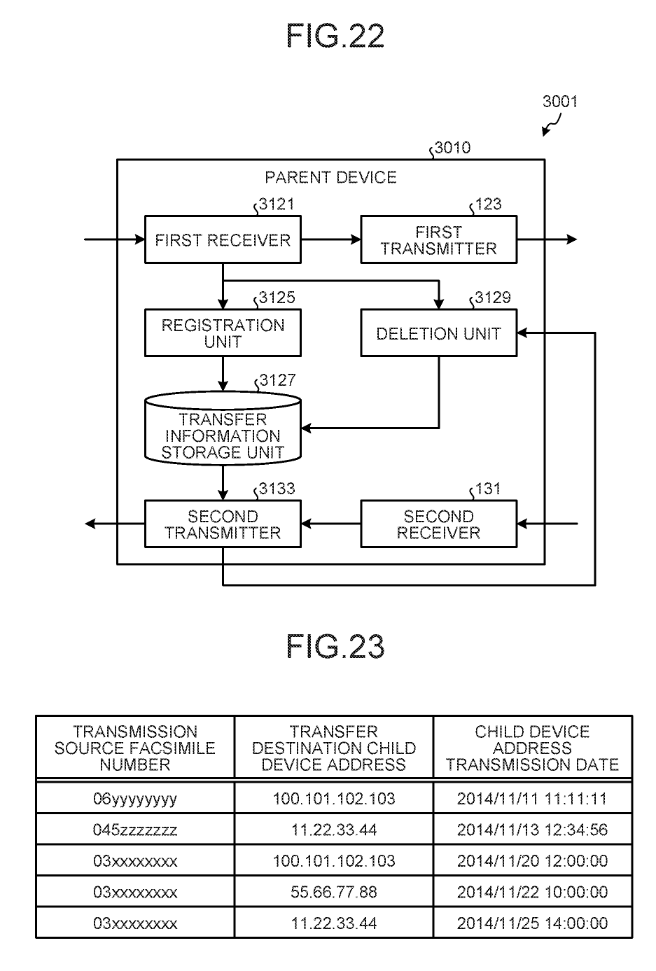

FIG. 22 is a block diagram of an exemplary functional configuration of the parent device 3010 according to the modification 3. As shown in FIG. 22, the parent device 3010 according to the modification 3 has a difference from the parent device 10 of the embodiment in a first receiver 3121, a registration unit 3125, a transfer information storage unit 3127, a deletion unit 3129, and a second transmitter 3133.

The first receiver 3121 receives, from any one of child devices 3020 via the internal network, facsimile request information that associates, with one another, a first image, transmission-destination-information representing a transmission destination to which the first image is to be transmitted, transmission-source-information-processing-apparatus-identifying-information representing a child device 20 from which the first image is transmitted, reply-necessary/unnecessary-information, and date information. The reply-necessary/unnecessary-information represents whether to accept a reply to transmission of a facsimile of the first image and the date information represents the date at which the child device 3020 transmits the facsimile request information.

When the reply-necessary/unnecessary-information contained in the facsimile request information received by the first receiver 3121 represents that the reply is necessary, the registration unit 3125 registers, in the transfer information storage unit 3127, transfer information that associates, with one another, first-transmission-source-information where the transmission source is the transmission destination represented by the transmission-destination-information contained in the facsimile request information, transfer-destination-information-processing-apparatus-identifying-information where the transfer destination is the information processing apparatus represented by the transmission-source-information-processing-apparatus-identifying-information contained in the facsimile request information, and the date information contained in the facsimile request information. When the reply-necessary/unnecessary-information represents that the reply is unnecessary, the registration unit 3125 does not register transfer information in the transfer information storage unit 3127.

FIG. 23 is a table of an exemplary transfer list that is stored in the transfer information storage unit 3127 of the modification 3. The transfer list consists of five sets of transfer information. According to the example shown in FIG. 23, the transmission source facsimile numbers (first-transmission-source-information) are the facsimile numbers of external facsimile apparatuses 30 serving as transmission sources, the transfer destination child device addresses (transfer-destination-information-processing-apparatus-identifying-information) are the IP address of child devices 20 serving as transfer destinations, and the child device transmission dates are sets of date information contained in sets of facsimile request information. According to the example shown in FIG. 23, the transfer information in the fifth row is registered also according to the facsimile request information shown in FIG. 5.

Each time the first transmitter 123 transmits a facsimile, the registration unit 3125 register, in the transfer information storage unit 3127, transfer information according to the facsimile request information received by the first receiver 3121.

When there are multiple sets of first-transmission-source-information each representing the transmission source that matches the transmission source represented by second-transmission-source-information in the transfer information registered in the transfer information storage unit 3127, the second transmitter 3133 transmits the second image via the internal network 2 to the child device 3020 represented by the transfer-destination-information processing-apparatus-identifying-information associated with the date information representing the oldest date among the sets of date information associated respectively with the sets of first-transmission-source-information.

For example, it is assumed that the second-transmission-source-information received by the second receiver 131 is “03xxxxxxxx” and the transfer information registered in the transfer information storage unit 3127 is as shown in FIG. 23. In this case, the second transmitter 3133 transmits the second image to the child device 3020 represented by “100.101.102.103” that is the transfer destination child device address associated with “2014/11/20 12:00:00” that is the oldest date among “2014/11/20 12:00:00”, “2014/11/22 10:00:00” and “2014/11/25 14:00:00” that are the child device transmission dates contained in the sets of transfer information in the third to fifth rows where the transmission source facsimile number is “03xxxxxxxx”.

When the second transmitter 3133 makes a reply by using the transfer information, the deletion unit 3129 deletes the transfer information from the transfer information storage unit 3127. For example, in the example shown in FIG. 23, when the second transmitter 3133 makes a reply by using the transfer information in the third row, the deletion unit 3129 deletes the transfer information in the third row from the transfer information storage unit 3127.

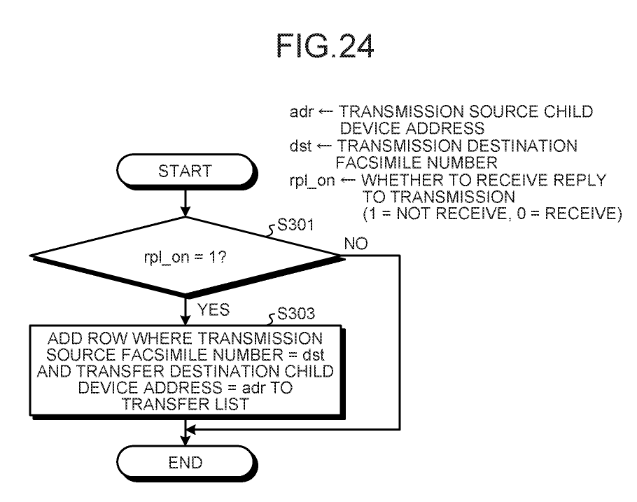

FIG. 24 is a flowchart of an exemplary registration process executed by the parent device 3010 of the modification 3.

When reply-necessary/unnecessary-information (rpl_on) contained in the facsimile request information received by the first receiver 3121 represents that the reply is necessary (1) (YES at step S301), the registration unit 3125 additionally registers, in the transfer list, a row of transfer information where the transmission source facsimile number is the transmission destination facsimile number (dst) contained in the facsimile request information and the transfer destination child device address is the transmission source child device address (adr) contained in the facsimile request information (step S303).

On the other hand, when it is NO at step S301, the processing at step S303 is not performed.

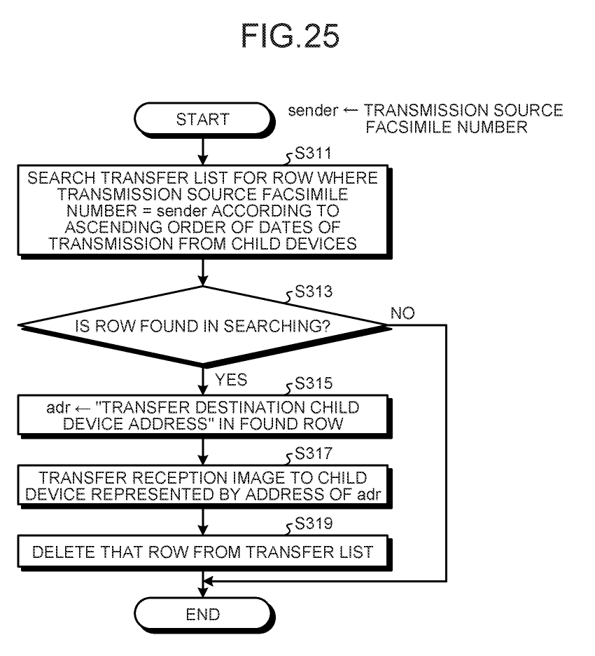

FIG. 25 is a flowchart of an exemplary transfer process executed by the parent device 3010 of the modification 3.

The second transmitter 3133 first searches the transfer list stored in the transfer information storage unit 3127 for a row of transfer information where the transmission source facsimile number matches the transmission source facsimile number (sender) received by the second receiver 131 according to the ascending order of transmission dates at which the child devices 3020 transmit first images (step S311). Because sets of transfer information are arranged in the transfer list according to the ascending order of the transmission dates at which the child devices 3020 transmit first images, it is assumed that sequentially searching the transfer information from the top leads to searching the transfer information according to the ascending order of transmission dates at which the child devices 3020 transmit first images.

When a row of transfer information where the transmission source facsimile number matches the transmission source facsimile number (sender) received by the second receiver 131 is found (YES at step S313), the second transmitter 3133 sets the transfer destination child device address in the found row of transfer information for a transfer destination (adr) to which the reception image received by the second receiver 131 is to be transferred (step S315) and transfers the reception image to the child device 3020 represented by the transfer destination child device address that is set for the transfer destination (adr) (step S317).

The deletion unit 3129 then deletes the transfer information that is used (searched for) by the second transmitter 3133 to make a reply from the transfer information storage unit 3127 (step S319).

When it is NO at step S313, the process ends.

As describe above, according to the modification 3, because it is possible to specify, in the parent device 3010, whether the child device 3020 receives a reply facsimile from the transmission destination, the child device 3020 can receive a reply facsimile when a replay is necessary. Because facsimile replies tend to be made according to the ascending order of transmission dates, according to the modification 3, the parent device 3010 is able to transfer a reply facsimile to an appropriate child device 3020.

Modification 4

For modification 4 of the embodiment, an example will be described where a child device to which a reply facsimile (second image) is to be transferred is determined by further using similarity between the second image (reception image) and a first image (transmission image) according to the modification 3. Differences from the modification 3 will be mainly described below and components having the same functions as those of the modification 3 are denoted with the same names and reference numerals as those of the modification 3 to omit descriptions of the components.

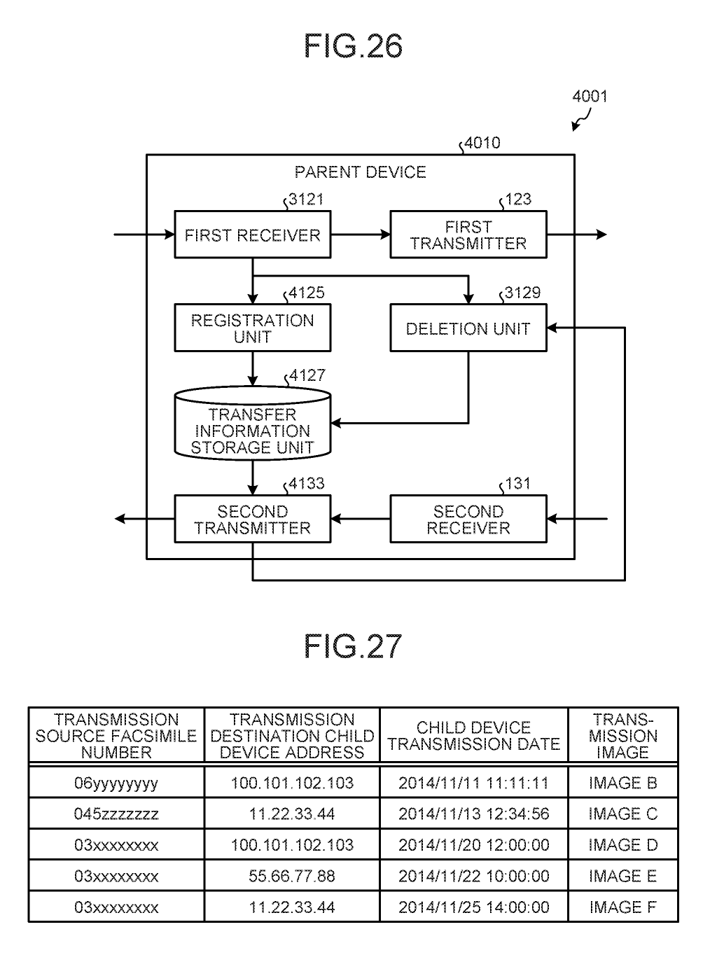

FIG. 26 is a block diagram of an exemplary functional configuration a parent device 4010 of a facsimile system 4001 according to the modification 4. As shown in FIG. 26, the parent device 4010 of the modification 4 has a difference from the parent device 3010 of the modification 3 in a registration unit 4125, a transfer information storage unit 4127, and a second transmitter 4133.

Each time the first transmitter 123 transmits a facsimile, when the reply-necessary/unnecessary-information contained in facsimile request information received by the first receiver 3121 represents that the reply is necessary, the registration unit 4125 registers, in the transfer information storage unit 4127, transfer information that associates, with one another, first-transmission-source-information where the transmission source is the transmission destination represented by the transmission-destination-information contained in the facsimile request information, the transfer destination information processing apparatus identifying information where the transmission destination is the information processing apparatus represented by the transmission-source-information-processing-apparatus-identifying-information contained in the facsimile request information, the date information contained in the facsimile request information, and the first image contained in the facsimile request information.

FIG. 27 is a table of an exemplary transfer list stored in the transfer information storage unit 4127 of the modification 4. The transfer list consists of five sets of transfer information. According to the example shown in FIG. 27, the transmission source facsimile numbers (first-transmission-source-information) are the facsimile numbers of external facsimile apparatuses 30 serving as transmission sources, the transfer destination child device addresses (transfer-destination-information-processing-apparatus-identifying-information) are the IP addresses of child devices 3020 serving as transfer destinations, the child device transmission dates are sets of date information contained in sets of facsimile request information, and the transmission images are first images contained in sets of facsimile request information. According to the example shown in FIG. 27, the transfer information in the fifth row is registered according to the facsimile request information shown in FIG. 5.

When, in the transfer information registered in the transfer information storage unit 4127, there are multiple sets of first-transmission-source-information each representing the transmission source that matches the transmission source represented by the second-transmission-source-information, the second transmitter 4133 transmits the second image via the internal network 2 to the child device 3020 represented by the transfer-destination-information-processing-apparatus-identifying-information that is associated with each of at least one first image having similarity with the second image exceeding a threshold among first images associated respectively with the sets of first transmission source information and with which the date information representing the oldest date is associated.

For example, it is assumed that the second-transmission-source-information received by the second receiver 131 is “03xxxxxxxx”, the second image (reception image) is “IMAGE G”, and the transfer information registered in the transfer information storage unit 4127 is as shown in FIG. 27. In this case, the second transmitter 4133 calculates the similarity between each of “IMAGE D”, “IMAGE E” and “IMAGE F” that are transmission images (first images) contained in the sets of transfer information in the third to fifth rows where the transmission source facsimile number is “03xxxxxxxx” with “IMAGE G” in the example shown in FIG. 27. For the method of calculating the similarity, a known method, such as pattern matching, may be used. It is assumed here that the similarity between “IMAGE D” and “IMAGE G” and the similarity between “IMAGE F” and “IMAGE G” exceed the threshold. For this reason, the second transmitter 4133 transmits the second image to the child device 3020 represented by “100.101.102.103” that is the transfer destination child device address associated with “2014/11/20 12:00:00” that is the oldest date among “2014/11/20 12:00:00” and “2014/11/25 14:00:00” that are child device transmission dates associated with “IMAGE D” and “IMAGE F” that are transmission images.

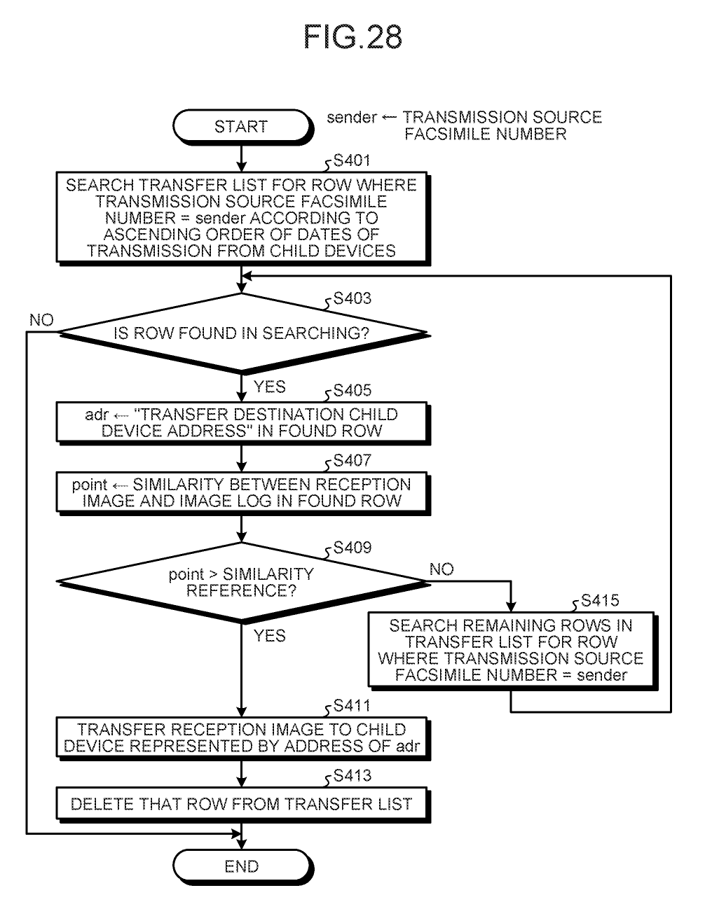

FIG. 28 is a flowchart of an exemplary transfer process executed by the parent device 4010 of the modification 4.

First, the second transmitter 4133 searches the transfer list stored in the transfer information storage unit 4127 for a row of transfer information where the transmission source facsimile number matches the transmission source facsimile number (sender) received by the second receiver 131 according to the ascending order of transmission dates at which child devices 3020 transmit first images (step S401). Because sets of transfer information are arranged in the transfer list according to the ascending order of the transmission dates at which child devices 3020 transmit first images, it is assumed that sequentially searching the transfer information from the top leads to searching the transfer information according to the ascending order of transmission dates at which child devices 3020 transmit first images.

When a row of transfer information where the transmission source facsimile number matches the transmission source facsimile number (sender) received by the second receiver 131 is found (YES at step S403), the second transmitter 4133 sets the transfer destination child device address in the found row of transfer information for a destination (adr) to which the reception image received by the second receiver 131 is to be transferred (step S405) and calculates the similarity (point) between the reception image and the transmission image in the found row of transfer information (step S407).

When the calculated similarity (point) is larger than the threshold (YES at step S409), the second transmitter 4133 transfers the reception image to the child device 3020 represented by the transfer destination child device address that is set for the transfer destination (adr) (step S411).

The deletion unit 3129 then deletes the transfer information that is used (searched for) by the second transmitter 4133 to make a reply from the transfer information storage unit 4127 (step S413).

On the other hand, when it is NO at step S409, the second transmitter 4133 then searches the rows of transfer information that have not been searched in the transfer list stored in the transfer information storage unit 4127 for a row of transfer information where the transmission source facsimile number matches the transmission source facsimile number (sender) received by the second receiver 131 (step S415) and the process goes back to step S403.

When it is YES at step S403, the process goes to step S405. When it is NO at step S403, the process ends.

Facsimile replies tend to be made according to the ascending order of transmission dates; however, the order is not limited to this. Furthermore, because a facsimile reply tends to be made by adding a comment to a transmitted facsimile, a reception image tends to be similar to a transmission image. For this reason, according to the modification 4, the parent device 4010 can transfer a reply facsimile to an appropriate child device 3020.

Modification 5

For Modification 5 of the embodiment, an example will be described where a child device makes a notification to a parent device on whether a child device has received a reply facsimile to a transmission facsimile. Differences from the modification 3 will be mainly described below and components having the same functions as those of the modification 3 are denoted with the same names and reference numerals as those of the modification 3 to omit descriptions of the components.

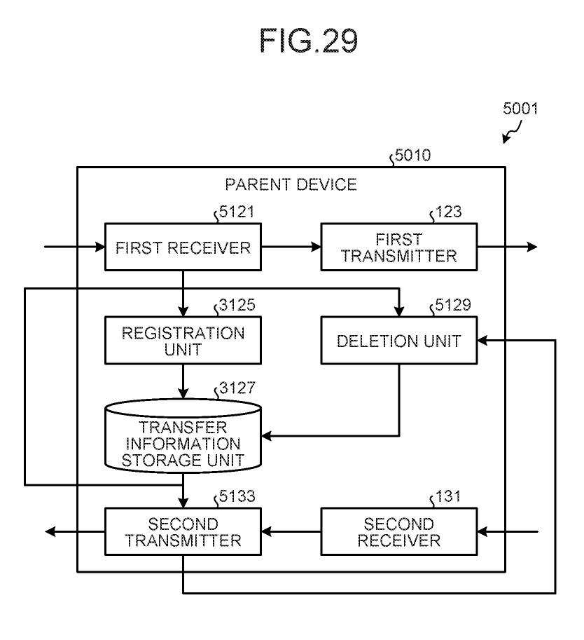

FIG. 29 is a block diagram of an exemplary functional configuration of a parent device 5010 of a facsimile system 5001 according to the modification 5. As shown in FIG. 29, the parent device 5010 of the modification 5 has a different from the parent device 3010 of the modification 3 in a first receiver 5121, a deletion unit 5129 and a second transmitter 5133.

The first receiver 5121 further receives, via the internal network 2, a reply result information representing whether making a replay has completed from a child device 5020 to which a second image is transmitted from the second transmitter 5133.

When a reply is made by using the transfer information and the reply result information received by the first receiver 5121 represents that the reply has completed, the deletion unit 5129 deletes the transfer information from the transfer information storage unit 3127.

When, in the transfer information registered in the transfer information storage unit 3127, there are multiple sets of first-transmission-source-information each representing the transmission source that matches the transmission source represented by second-transmission-source-information, the second transmitter 5133 transmits together the second image and reply check information for checking whether making a replay has completed via the internal network 2 to the child device 5020 represented by transfer-destination-information-processing-apparatus-identifying-information associated with the date information representing the oldest date among the sets of date information associated respectively with the sets of first-transmission-source-information.

When reply result information received by the first receiver 5121 represents that a replay has not completed, the second transmitter 5133 transmits together, via the network 2, the second image and reply check information for checking whether making a reply has completed to the child device 5020 represented by the transfer-destination-information-processing-apparatus-identifying-information associated with the date information representing the next old date following the date represented by the date information associated with the transfer-destination-information-processing-apparatus-identifying-information representing the child device 5020 to which the second image is transmitted at the previous time among sets of date information associated respectively with multiple sets of first-transmission-source-information.

For example, it is assumed that the second-transmission-source-information received by the second receiver 131 is “03xxxxxxxx”, the transfer information registered in the transfer information storage unit 3127 is as shown in FIG. 23, the second transmitter 5133 transmits the second image to the child device 5020 represented by “100.101.102.103” that is the transfer destination child device address associated with “2014/11/20 12:00:00” that is the child device transmission date, and the reply result information received from the child device 5020 by the first receiver 5121 represents that the reply has not completed. In this case, the second transmitter 5133 transmits the second image to the child device 5020 represented by “55.66.77.88” that is the transfer destination child device address associated with “2014/11/22 10:00:00” that is the next old date following “2014/11/20 12:00:00” that is the previous date among “2014/11/20 12:00:00”, “2014/11/22 10:00:00” and “2014/11/25 14:00:00” that are the child device transmission dates contained in the sets of transfer information in the third to fifth rows where the transmission facsimile number is “03xxxxxxxx” in the example shown in FIG. 23.

Note that, when the child device 5020 that has transmitted the reply result information received by the first receiver 5121 and representing that a replay has not completed is the child device 5020 represented by the transfer-destination-information-processing-apparatus-identifying-information associated with the date information representing the latest date among sets of date information associated respectively with the sets of first-transmission-source-information, the second transmitter 5133 may transmit the second image via the network 2 to the child device 5020 that is a pre-determined (default) child device 5020 to which the second image has not been transmitted.

For example, it is assumed that the second-transmission-source-information received by the second receiver 131 is “03xxxxxxxx”, the transfer information registered in the transfer information storage unit 3127 is as shown in FIG. 23, the second transmitter 5133 transmits the second image to the child device 5020 represented by “11.22.33.44” that is the transfer destination child device address associated with “2014/11/25 14:00:00” that is the child device transmission date, and the reply result information received from the child device 5020 by the first receiver 5121 represents that a replay has not completed. In this case, the second transmitter 5133 may transmit the second image to a child device 5020 that is a predetermined (default) child device 5020 to which the second image has not been transmitted. Note that it is assumed that the second transmitter 5133 does not transmit reply check information to the predetermined (default) child device 5020.

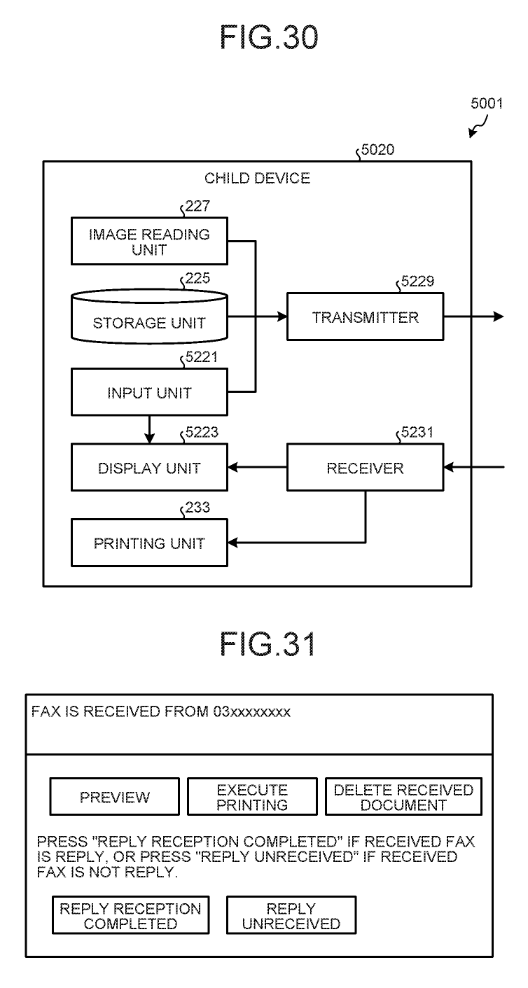

FIG. 30 is a block diagram of an exemplary functional configuration of the child device 5020 of the modification 5. As shown in FIG. 30, the child device 5020 in the modification 5 has a difference from the child device 3020 of the modification 3 in an input unit 5221, a display unit 5223, a transmitter 5229 and a receiver 5231.

The receiver 5231 receives together the second image and the reply check information from the parent device 5010 via the internal network 2 and causes the display unit 5223 to display a reply check screen like that shown in FIG. 31. The user of the child device 5020 displays a preview in the reply check screen or causes the printing unit 233 to execute printing to check whether the second image is a reply facsimile. When the second image received by the receiver 5231 is a reply facsimile, the input unit 5221 makes an input representing that reception of reply has completed according to a user operation on the reply check screen. When the second image is not a reply facsimile, the input unit 5221 makes an input representing that no reply has been received according to a user operation to input reply result information. The transmitter 5229 acquires the reply result information input by the input unit 5221 and transmits the reply result information to the parent device 5010 via the internal network 2.

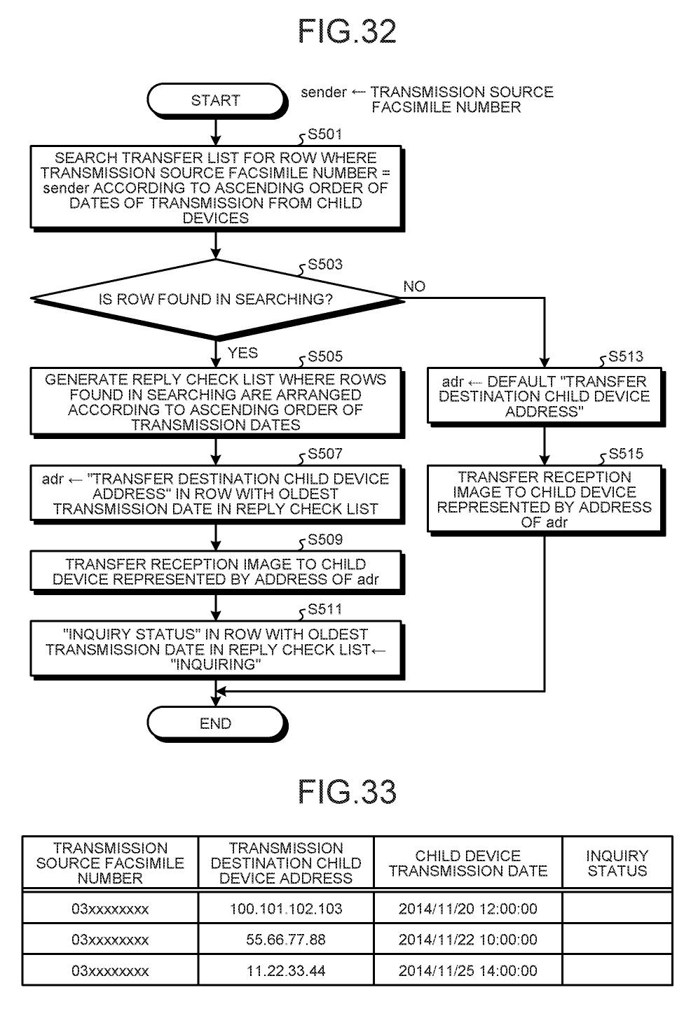

FIG. 32 is a flowchart of an exemplary transfer process executed by the parent device 5010 when a reception image is received according to the modification 5.

The second transmitter 5133 searches a transfer list stored in the transfer information storage unit 3127 for a row of transfer information where the transmission source facsimile number matches the transmission source facsimile number (sender) that is received by the second receiver 131 according to the ascending order of transmission dates at which child devices 5020 transmit first images (step S501). It is here assumed that, because the sets of transfer information are arranged according to the ascending order of transmission dates at which child devices 5020 transmit first images in the transfer list, searching the transfer information from the top leads to searching the transfer information according to the ascending order of transmission dates at which the child devices 5020 transmit first images.

When a row of transfer information where the transmission source facsimile number matches the transmission source facsimile number (sender) that is received by the second receiver 131 is found (YES at step S503), the second transmitter 5133 arranges the found row of transfer information according to the ascending order of transmission dates and generates a reply check list to which inquiry status is added (step S505).

FIG. 33 is a table of an exemplary reply check list according to the modification 5. FIG. 33 shows a reply check list in the case where the second-transmission-source-information received by the second receiver 131 is “03xxxxxxxx” and the transfer information registered in the transfer information storage unit 3127 is as shown in FIG. 23. When the reply check list is generated, the inquiry status is empty.

The second transmitter 5133 then sets, for the transfer destination (adr) to which the reception image received by the second receiver 131 is to be transferred, the transfer destination child device address of the row with the oldest transmission date at which a child device 5020 transmits a first image in the reply check list (step S507) and transfers the reception image to the child device 5020 represented by the transfer destination child device address that is set for the transfer destination (adr) (step S509).

The second transmitter 5133 then makes a setting to represent that an inquiry is being made in the inquiry status in the row with the oldest transmission date at which a child device 5020 transmits a first image in the reply check list (step S511).

On the other hand, when it is NO at step S503, the second transmitter 5133 sets the transfer destination child device address of the default child device 5020 for the transfer destination (adr) to which the reception image received by the second receiver 131 is to be transferred (step S513) and transfers the reception image to the child device 5020 represented by the transfer destination child device address that is set for the transfer destination (step S515).

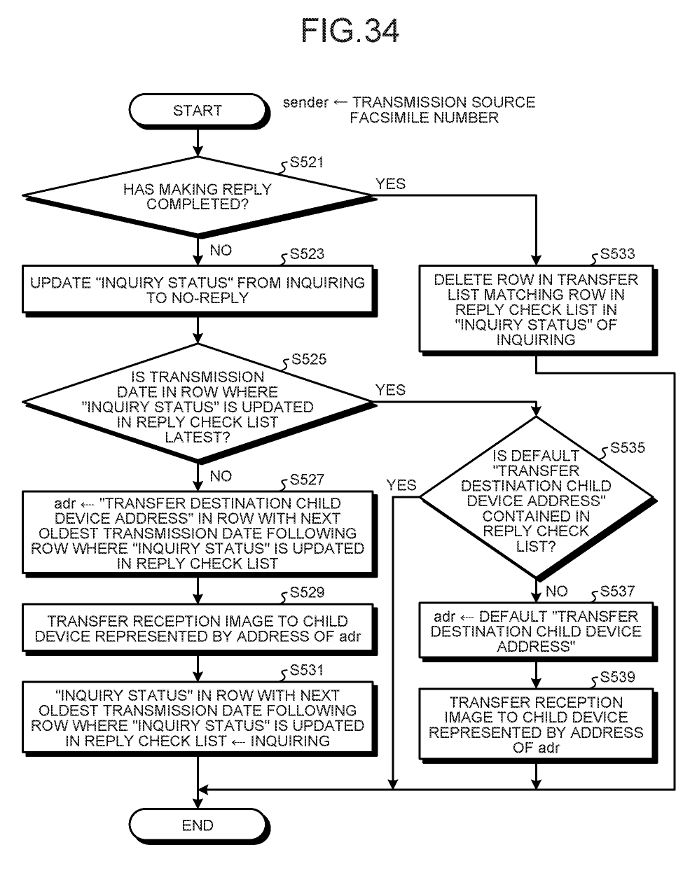

FIG. 34 is a flowchart of an exemplary transfer process executed by the parent device 5010 when reply result information is received according to the modification 5.

When the reply result information that is transmitted from the child device 5020 to which the reception image is transmitted and that is received by the first receiver 5121 represents that making a reply has not completed (NO at step S521), the second transmitter 5133 updates the inquiry status representing that an inquiry is being made in the reply check list to represent that no reply has been made (step S523).

When the transmission date at which the child device 5020 transmits a first image in the row where the inquiring status is updated to non-reply status in the reply check list is not the latest (NO at step S525), the second transmitter 5133 sets, for the transfer destination (adr) to which the reception image received by the second receiver 131 is to be transferred, the transfer destination child device address in the row where the transmission date at which a child device 5020 transmits a first image is the next oldest following that in the row where the inquiring status is updated to the non-reply status in the reply check list (step S527) and transfers the reception image to the child device 5020 represented by the transfer destination child device address that is set for the destination (adr) (step S529).

The second transmitter 5133 then makes a setting to represent that an inquiry is being made in the inquiry status in the row with the next oldest transmission date at which a child device 5020 transmits a first image, following that in the row where the inquiry state is updated to represent that no reply has been made (step S531).

When it is YES at step S521, the second transmitter 5133 then deletes the reply check list and the deletion unit 5129 deletes, from the transfer information storage unit 3127, the row of transfer information in the transfer list that matches the row in the reply check list in inquiry status representing that an inquiry is being made (in transmission source facsimile number, transfer destination child device address, and child device transmission date) (step S533).

When it is YES at step S525 and if the transfer destination child device addresses in the reply check list contain the transfer destination child device address of the default child device 5020 (YES at step S535), the second transmitter 5133 deletes the rely check list and ends the process.

On the other hand, when the transfer destination child device addresses in the reply check list do not contain the transfer destination child device address of the default child device 5020 (NO at step S535), the second transmitter 5133 sets the transfer destination child device address of the default child device 5020 (step S537) for the destination (adr) to which the reception image received by the second receiver 131 is to be transferred, transfers the reception image to the child device 5020 represented by the transfer destination child device address that is set for the transfer destination (adr) (step S539), and deletes the reply check list.

According to the modification 5, because the parent device 5010 does not delete the transfer information before the reply from the child device 5020 notifies that the reply has completed, the child device can receive a reply facsimile accurately.

Modification 6

For Modification 6 of the embodiment, a case will be described where a parent device further specifies, into a child device, a paper ejection destination for predetermined use. Differences from the embodiment will be mainly described below and components having the same functions as those of the embodiment are denoted with the same names and reference numerals as those of the embodiment to omit descriptions of the components.

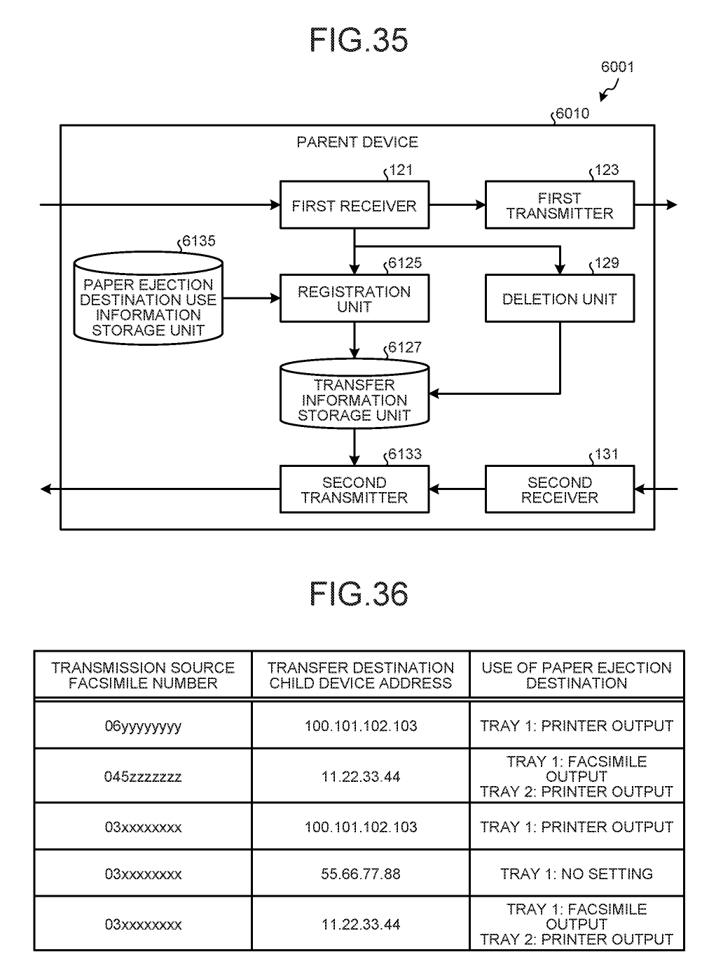

FIG. 35 is a block diagram of an exemplary functional configuration of a parent device 6010 of a facsimile system 6001 according to the modification 6. As shown in FIG. 35, the parent device 6010 of the modification 6 has a difference from the parent device 10 of the embodiment in a registration unit 6125, a transfer information storage unit 6127, a second transmitter 6133, and an ejection destination use information storage unit 6135.

The ejection destination use information storage unit 6135 stores, for each child device 20, ejection destination use information representing at least one paper ejection destination of the child device 20 and use of each of at least one ejection destination.

The registration unit 6125 acquires, from the paper ejection destination use information storage unit 6135, paper ejection destination use information for the child device 20 that transmits the facsimile request information received by the first receiver 121 and registers, in the transfer information storage unit 6127, transfer information that associates first-transmission-source-information where the transmission source is the transmission destination represented by the transmission-destination-information contained in the facsimile request information, transfer-destination-information-processing-apparatus-identifying-information where the transfer destination is the information processing apparatus represented by the transmission-source-information-processing-apparatus-identifying-information contained in the facsimile request information, and the acquired paper ejection destination use information.

FIG. 36 is a table of an exemplary transfer list that is stored in the transfer information storage unit 6127 of the modification 6. The transfer list consists of five sets of transfer information. According to the example shown in FIG. 36, the transmission source facsimile numbers (first-transmission-source-information) are the facsimile numbers of external facsimile apparatuses 30 serving as transmission sources, the transfer destination child device addresses (transfer-destination-information-processing-apparatus-identifying-information) are the IP addresses of child devices 20 serving as transfer destinations, and the paper ejection destination use is the paper ejection use information that is acquired from the paper ejection destination use information storage unit 6135. As shown in FIG. 36, the paper ejection destination use is, for example, printer output or facsimile output; however, the paper ejection destination use is not limited to them. According to the example shown in FIG. 36, the transfer information in the fifth row is registered according to the facsimile request information shown in FIG. 5.

When the transmission source represented by the second-transmission-source-information matches the transmission source represented by the first-transmission-source-information contained in the transfer information registered in the transfer information storage unit 6127, the second transmitter 6133 specifies a paper ejection destination for predetermined use among at least one paper ejection destination represented by the paper ejection use information contained in the transfer information and transmits a second image to the child device 20 represented by the transfer-destination-information-processing-apparatus-identifying-information. According to the modification 6, it is assumed that the paper ejection destination for predetermined use is a tray for facsimile output; however, the paper ejection destination for predetermined use is not limited to this.

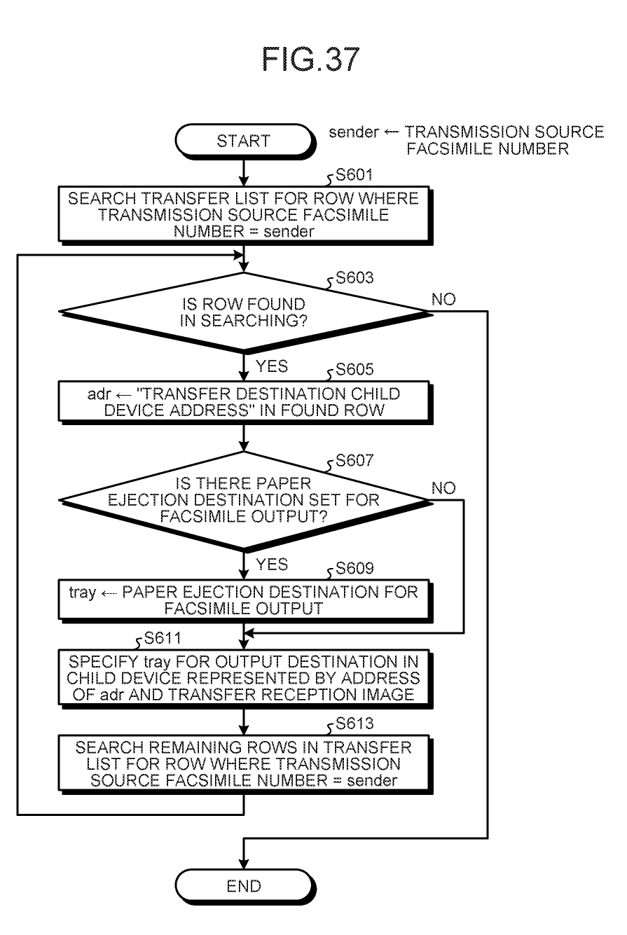

FIG. 37 is a flowchart of an exemplary transfer process that is executed by the parent device 6010 according to the modification 6.

First, the second transmitter 6133 searches the transfer list stored in the transfer information storage unit 6127 for a row of transfer information where the transmission source facsimile number matches the transmission source facsimile number (sender) that is received by the second receiver 131 (step S601).

When a row of transfer information where the transmission source facsimile number matches the transmission source facsimile number (sender) received by the second receiver 131 is found (YES at step S603), the second transmitter 6133 sets the transfer destination child device address in the found row of transfer information for the transfer destination (adr) to which the reception image received by the second receiver 131 is to be transferred (step S605).

When the paper ejection destination use information in the found row of transfer information represents a tray (paper ejection destination) for facsimile output (YES at step S607), the second transmitter 6133 sets the tray for facsimile output for the output destination (tray) to which the reception image received by the second receiver 131 is to be output (step S609).

Note that, when it is NO at step S607, the processing at step S609 is not performed and the output destination (tray) to which the reception image received by the second receiver 131 is to be output is set by default.

The second transmitter 6133 then specifies an output destination (tray) in the child device 20 represented by the transfer destination child device address that is set for the transfer destination (adr) and transfers the reception image (step S611).

The second transmitter 6133 searches rows of transfer information that have not been searched in the transfer list stored in the transfer information storage unit 6127 for a row of transfer information where the transmission source facsimile number matches the transmission source facsimile number (sender) received by the second receiver 131 (step S613) and the process goes back to step S603.

When it is YES at step S603, the process goes to step S605. When it is NO at step S603, the process ends.

According to the modification 6, when the tray for facsimile output is set in the child device 20, it is possible to output the received facsimile to that tray.

Modification 7

For Modification 7 of the embodiment, an example will be described where a parent device further specifies, into a child device, a paper ejection destination corresponding to the result of analyzing a second image (reception image). Differences from the embodiment will be mainly described below and components having the same functions as those of the embodiment are denoted with the same names and reference numerals as those of the embodiment to omit descriptions of the components.

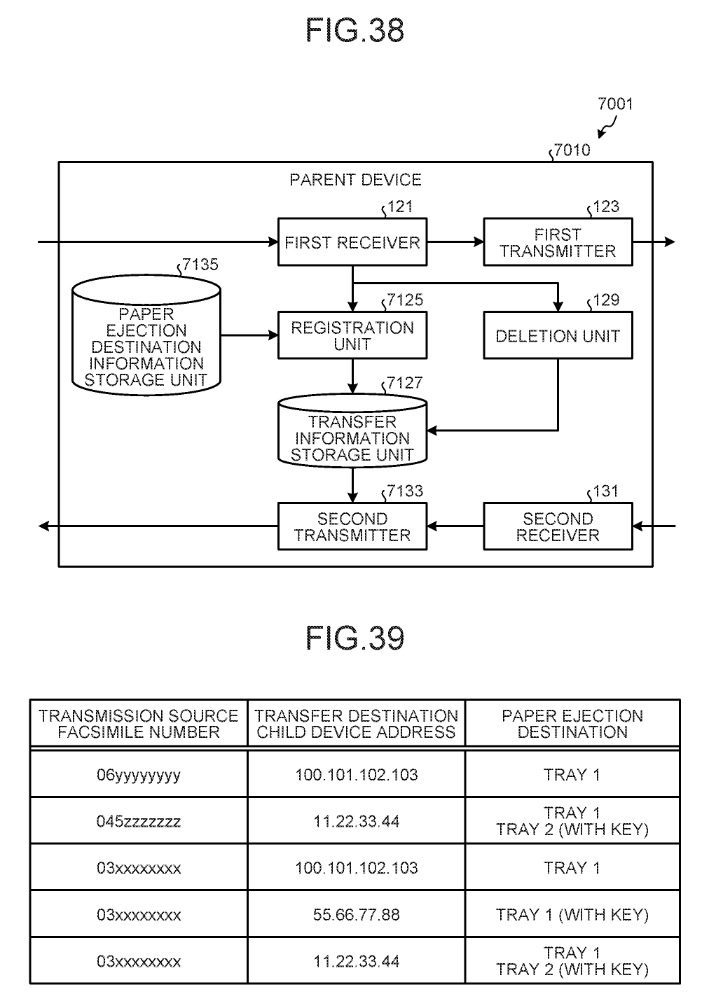

FIG. 38 is a block diagram of an exemplary functional configuration of a parent device 7010 of a facsimile system 7001 according to the modification 7. As shown in FIG. 38, the parent device 7010 of the modification 7 has a difference from the parent device 10 of the embodiment in a registration unit 7125, a transfer information storage unit 7127, a second transmitter 7133 and a paper ejection destination information storage unit 7135.

The paper ejection destination information storage unit 7135 stores, for each child device 20, paper ejection destination information representing at least one paper ejection destination of the child device 20.

The registration unit 7125 acquires, from the paper ejection destination information storage unit 7135, paper ejection destination information for the child device 20 that transmits the facsimile request information received by the first receiver 121 and registers, in the transfer information storage unit 7127, transfer information that associates, with one another, first-transmission-source-information where the transmission source is the transmission destination represented by the transmission-destination-information contained in the facsimile request information, the transfer-destination-information-processing-apparatus-identifying-information where the transfer destination is the information processing apparatus represented by the transmission source information processing apparatus identifying information contained in the facsimile request information, and the acquired paper ejection destination information.

FIG. 39 is a table of an exemplary transfer list that is stored in the transfer information storage unit 7127 according to the modification 7. The transfer list consists of five sets of transfer information. According to the example shown in FIG. 39, the transmission source facsimile numbers (first-transmission-source-information) are the facsimile numbers of external facsimile apparatuses 30 serving as transmission sources, the transfer destination child device addresses (transfer-destination-information-processing-apparatus-identifying-information) are the IP addresses of child devices 20 serving as transfer destinations, and the paper ejection destinations are the sets of paper ejection destination information acquired from the paper ejection destination information storage unit 7135. As shown in FIG. 39, the paper ejection destinations are, for example, a tray with a key and a normal tray (without key); however, the paper ejection destinations are not limited to them. Note that according to the example shown in FIG. 39, the transfer information in the fifth row is registered according to the facsimile request information shown in FIG. 5.

The second transmitter 7133 analyzes the second image and, when the transmission source represented by the second-transmission-source-information matches the transmission source represented by the first-transmission-source-information contained in the transfer information registered in the transfer information storage unit 7127, the second transmitter 7133 specifies a predetermined paper ejection destination among at least one paper ejection destination represented by the paper ejection destination information contained in the transfer information and transmits the second image to the child device 20 represented by the transfer-destination-information-processing-apparatus-identifying-information.

For example, the second transmitter 7133 performs optical character recognition (OCR) processing on the second image and analyzes confidentiality of the second image. In this case, when a word, such as “confidential”, “internal user only” or “secret”, representing confidentiality is found, the second transmitter 7133 determines that the second image has confidentiality. Upon determining that the second image has confidentiality, the second transmitter 7133 specifies a tray with a key among at least one paper ejection destination represented by the paper ejection destination information contained in the transfer information and transmits the second image to the child device 20 represented by the transfer-destination-information-processing-apparatus-identifying-information.

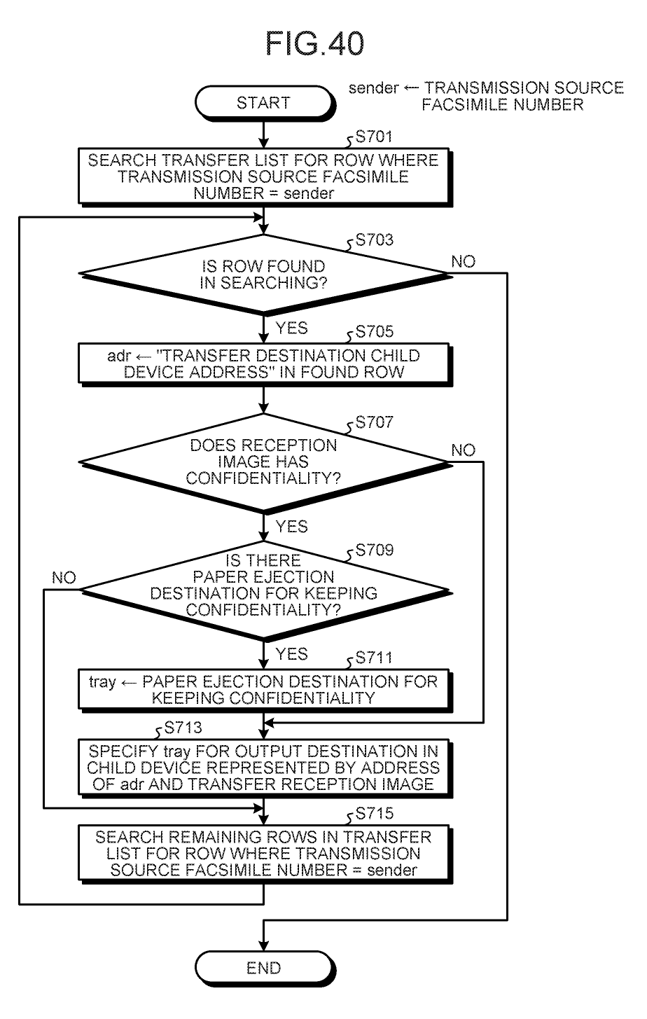

FIG. 40 is a flowchart of an exemplary transfer process executed by the parent device 7010 of the modification 7.

First, the second transmitter 7133 searches the transfer list stored in the transfer information storage unit 7127 for a row of transfer information where the transmission source facsimile number matches the transmission source facsimile number (sender) received by the second receiver 131 (step S701).

When a row of transfer information where the transmission source facsimile number matches the transmission source facsimile number (sender) received by the second receiver 131 is found (YES at step S703), the second transmitter 133 sets the transfer destination child device address in the found row of transfer information for the transfer destination (adr) to which the reception image received by the second receiver 131 is to be transferred (step S705).

When the reception image received by the second receiver 131 has confidentiality (YES at step S707) and if the paper ejection destination information in the found row of transfer information represents a tray with a key for keeping confidentiality (paper ejection destination) (YES at step S709), the second transmitter 7133 sets the tray with a key for keeping confidentiality for the output destination (tray) to which the reception image received by the second receiver 131 is to be output (step S711). Before step S701, the second transmitter 7133 may previously perform an analysis on whether the reception image received by the second receiver 131 has confidentiality or may performs that analysis at step S707.

When it is NO at step S707, the processing at steps S709 and S711 is not performed and the output destination (tray) to which the reception image received by the second receiver 131 is to be output is set by default.

The second transmitter 7133 then specifies the output destination (tray) in the child device 20 represented by the transfer destination child device address that is set for the transfer destination (adr) and transfers the reception image (step S713).

When it is NO at step S709, the processing at steps S711 and S713 is not performed and the reception image received by the second receiver 131 is not transferred to the child device 20 represented by the transfer destination child device address that is set for the transfer destination (adr).

The second transmitter 7133 searches rows of transfer information in the transfer list stored in the transfer information storage unit 7127 for a row of transfer information where the transmission source facsimile number matches the transmission source facsimile number (sender) received by the second receiver 131 (step S715) and the process goes back to step S703.

When it is YES at step S703, the process goes to step S705. When it is NO at step S703, the process ends.

According to the modification 7, when the child device 20 has a tray for keeping confidentiality, a received facsimile having confidentiality is output to the tray. When the child device 20 has no tray for keeping confidentiality, the received facsimile with confidentiality is not transferred to the child device 20 and accordingly confidentiality can be maintained.

Modification 8

For modification 8 of the embodiment, an example will be described where a parent device further specifies, into a child device, a paper size of paper on which a received facsimile is printed. Differences from the embodiment will be mainly described below and components having the same functions as those of the embodiment are denoted with the same names and reference numerals as those of the embodiment to omit descriptions of the components.

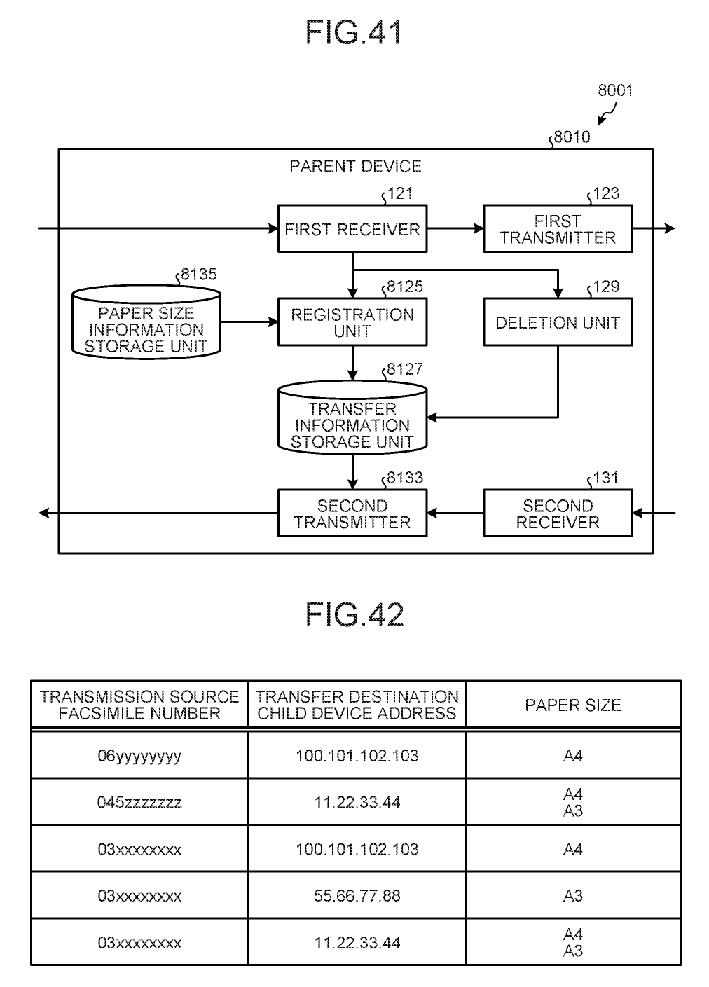

FIG. 41 is a block diagram of an exemplary functional configuration of a parent device 8010 of a facsimile system 8001 according to the modification 8. As shown in FIG. 41, the parent device 8010 of the modification 8 has a difference from the parent device 10 of the embodiment in a registration unit 8125, a transfer information storage unit 8127, a second transmitter 8133, and a paper size information storage unit 8135.

The paper size information storage unit 8135 stores, for each child device 20, paper size information representing at least one paper size printable by the child device 20.

The registration unit 8125 acquires, from the paper size information storage unit 8135, the paper size information for the child device 20 that transmits facsimile request information received by the first receiver 121 and registers, in the transfer information storage unit 8127, transfer information that associates, with one another, first-transmission-source-information where the transmission source is the transmission destination represented by transmission-destination-information contained in the facsimile request information, transfer destination information processing apparatus identifying information where the transfer destination is the information processing apparatus represented by the transmission-source-information-processing-apparatus-identifying-information contained in the facsimile request information, and the acquired paper size information.

FIG. 42 is a table of an exemplary transfer list that is stored in the transfer information storage unit 8127 according to the modification 8. The transfer list consists of five sets of transfer information. According to the example shown in FIG. 42, the transmission source facsimile numbers (first-transmission-source-information) are the facsimile number of external facsimile apparatuses 30 serving as transmission sources, the transfer destination child device addresses (transfer-destination-information-processing-apparatus-identifying-information) are the IP addresses of child devices 20 serving as transfer destinations, and the paper sizes are the paper size information that is acquired from the paper size information storage unit 8135. The paper sizes are, for example, A4 and A3 as shown in FIG. 42; however, the paper sizes are not limited to them. According to the example shown in FIG. 42, the transfer information in the fifth row is registered also according to the facsimile request information shown in FIG. 5.

When the transmission source represented by the second-transmission-source-information matches the transmission source represented by the first-transmission-source-information contained in the transfer information registered in the transfer information storage unit 8127, the second transmitter 8133 determines, by using the paper size information contained in the transfer information, whether the child device 20 represented by the transfer-destination-information-processing-apparatus-identifying-information can print the paper size corresponding to the second image. When the child device 20 can print that paper size, the second transmitter 8133 specifies the paper size corresponding to the second image and transmits the second image to the child device 20.

For example, it is assumed that the second-transmission-source-information received by the second receiver 131 is “045zzzzzzz”, the transfer information registered in the transfer information storage unit 8127 is as shown in FIG. 42, and the paper size corresponding to the second image is “A4”. In this case, the second transmitter 8133 specifies printing in “A4” in the child device 20 represented by “11.22.33.44” that is the transfer destination child device address contained in the transfer information in the second row where the transmission source facsimile number is “045zzzzzzz” and transmits the reception information.

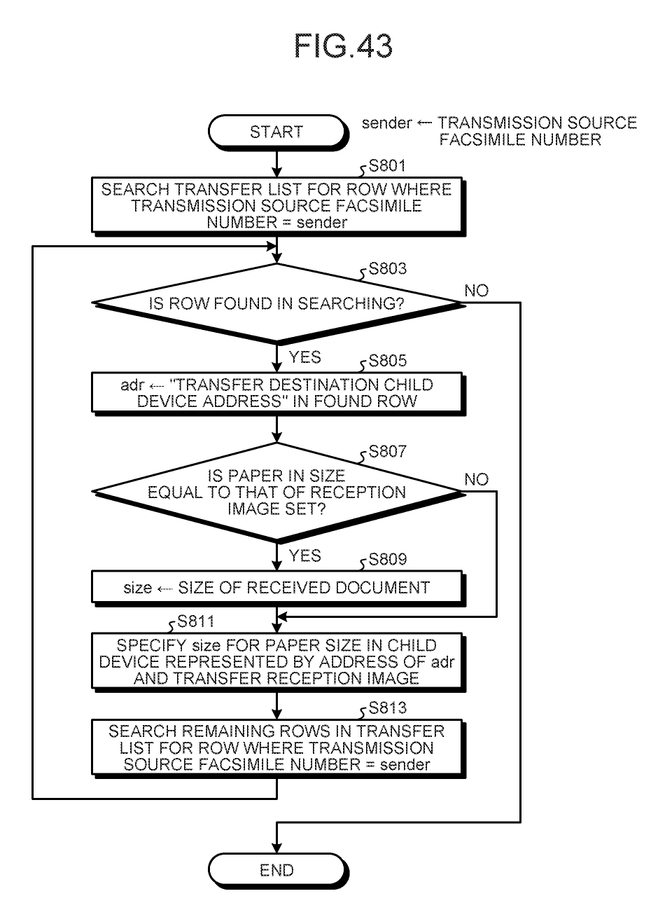

FIG. 43 is a flowchart of an exemplary transfer process that is executed by the parent device 8010 of the modification 8.

First, the second transmitter 8133 searches the transfer list stored in the transfer information storage unit 8127 for a row of transfer information where the transmission source facsimile umber matches the transmission source facsimile number (sender) received by the second receiver 131 (step S801).

When a row of transfer information where the transmission source facsimile number matches the transmission source facsimile number (sender) received by the second receiver 131 is found (YES at step S803), the second transmitter 8133 sets the transfer destination child device address in the found row of transfer information for the transfer destination (address) to which the reception image received by the second receiver 131 is to be transferred (step S805).

When the paper size information in the found row of transfer information represents the paper size corresponding to (equal to that of) the reception image (YES at step S807), the second transmitter 8133 sets the paper size corresponding to the reception image for the paper size (size) of paper on which the reception image received by the second receiver 131 is to be printed (step S809).

The second transmitter 8133 then specifies the paper size (size) in the child device 20 represented by the transfer destination child device address that is set for the transfer destination (adr) and transfers the reception image (step S811).

When it is NO at step S807, the processing at step S809 is not performed and the paper size (size) of the reception image received by the second receiver 131 is set by default.

The second transmitter 8133 then searches rows of transfer information that have not been searched in the transfer list stored in the transfer information storage unit 8127 for a row of transfer information where the transmission source facsimile number matches the transmission source facsimile number (sender) received by the second receiver 131 (step S813) and the process goes back to step S803.

When it is YES at step S803, the process goes to step S805. When it is NO at step S803, the process ends.

According to the modification 8, when the child device 20 is able to print the reception image in the paper size corresponding to the reception image, the received facsimile is printed in the paper size, which prevents scaling-down printing and occurrence of margin and thus improves visibility of the received facsimile.

Modification 9

For Modification 9 of the embodiment, an example will be described where, when a child device is not able to print the paper size corresponding to a reception image in the modification 8, an instruction for printing by using another child device that is able to print the paper size corresponding to the reception image is issued to a parent device. Differences from the modification 8 will be mainly described below and components having the same functions as those of the modification 8 are denoted with the same names and reference numerals as those of the modification 8 to omit descriptions of the components.

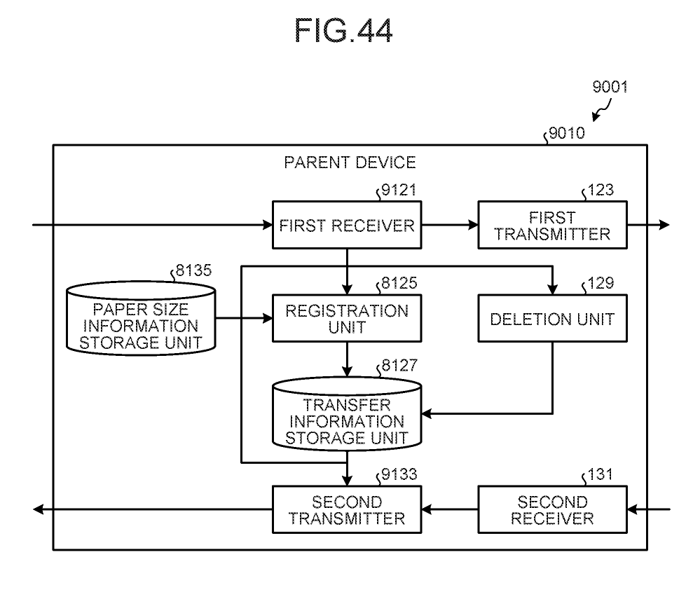

FIG. 44 is a block diagram of an exemplary functional configuration of a parent device 9010 of a facsimile system 9001 according to the modification 9. As shown in FIG. 44, the parent device 9010 according to the modification 9 has a difference from the parent device 8010 of the modification 8 in a first receiver 9121 and a second transmitter 9133.

When the transmission source represented by the second-transmission-source-information matches the transmission source represented by the first-transmission-source-information contained in the transfer information registered in the transfer information storage unit 8127, the second transmitter 9133 determines, by using the paper size information contained in the transfer information, whether the child device represented by the transfer-destination-information-processing-apparatus-identifying-information is able to print the paper size corresponding to the second image. When the child device 20 is not able to print the paper size, the second transmitter 9133 acquires sets of paper size information for the respective child devices 9020 from the paper size information storage unit 8135 and, by using the sets of paper sheet size information, specifies a child device 9020 that is able to print the paper sheet size corresponding to the second image. The second transmitter 9133 then transmits, to the child device 9020 represented by the transfer-destination-information-processing-apparatus-identifying-information, print enabling information processing apparatus information representing the specified child device 9020 and mismatch information representing that the paper size printable by the child device 9020 represented by the transfer-destination-information-processing-apparatus-identifying-information mismatches the paper size corresponding to the second image.

For example, it is assumed that the second-transmission-source-information received by the second receiver 131 is “06yyyyyyyy”, the transfer information registered in the transfer information storage unit 8127 is as shown in FIG. 42, and the paper size corresponding to the second image is “A3”. In this case, the child device 9020 represented by “100.101.102.103” that is the transfer destination child device address contained in the transfer information in the first row where the transmission source facsimile number is “06yyyyyyyy” in the example shown in FIG. 42 is not able print “A3”. For this reason, the second transmitter 9133 transmits, to the child device 9020 represented by “100.101.102.103”, the second image, the mismatch information representing that the paper size printable by the child device 9020 mismatches the paper size corresponding to the second image, and “11.22.33.44” and “55.66.77.88” that are the transfer destination child device addresses of child devices 9020 that are able to print “A3”.

The first receiver 9121 further receives print execution information processing apparatus information representing the child device 9020 that is to execute printing of the second image via the internal network 2 from the child device 9020 to which the mismatch information is transmitted by the second transmitter 9133.

The second transmitter 9133 specifies the paper size corresponding to the second image and transmits the second image via the internal network 2 to the child device 9020 represented by the print execution information processing apparatus information.

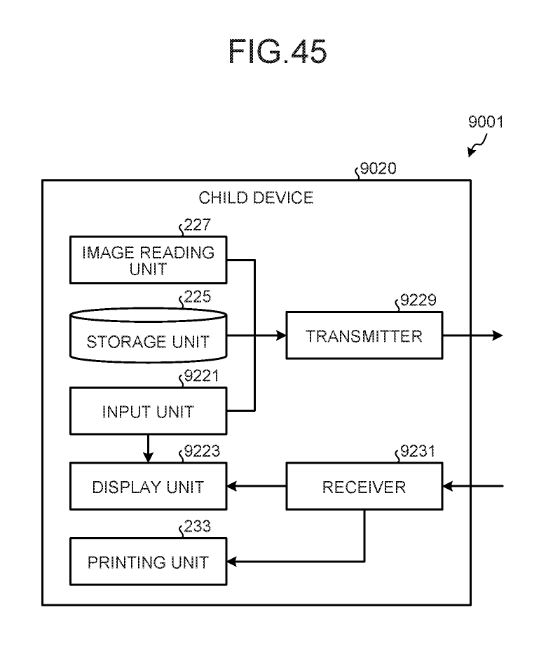

FIG. 45 is a block diagram of an exemplary functional configuration of the child device 9020 according to the modification 9. As shown in FIG. 45, the child device 9020 according to the modification 9 has a difference from the child device 8020 of the modification 8 in an input unit 9221, a display unit 9223, a transmitter 9229, and a receiver 9231.

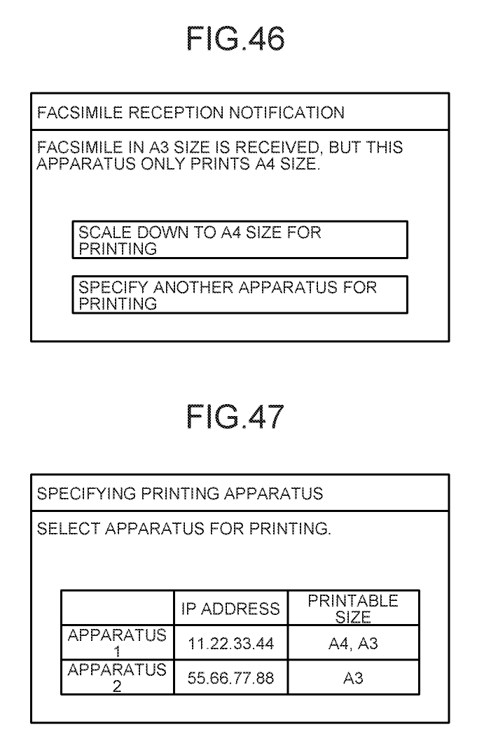

The receiver 9231 receives the mismatch information and the print enabling information processing apparatus information together with the second image from the parent device 9010 via the internal network 2. According to the mismatch information, the receiver 9231 causes the display unit 9223 to display a print selection screen like that shown in FIG. 46 for selecting whether to scale up/down the second image to a paper size printable by the child device 9020 to print the second image or print the second image by using another child device 9020 that is able to print the second image in the paper size corresponding to the second image.

When the input unit 9221 selects printing by using another child device 9020 according to a user operation, the display unit 9223 displays, according to the print enabling information processing apparatus information, a list screen that is shown in FIG. 47 and is representing a list of other child devices 9020 that are able to print the paper size corresponding to the second image. The input unit 9221 then selects another child device 9020 that performs printing according to a user operation, thereby inputting print execution information processing apparatus information representing the address of the child device 9020. The transmitter 9229 acquires the print execution information processing apparatus information that is input by the input unit 9221 and transmits the print execution information processing apparatus information via the internal network 2 to the parent device 9010.

When the input unit 9221 selects ascaling up/down printing according to a user operation on the print selection screen, the printing unit 233 scales up/down the second image to print the second image.

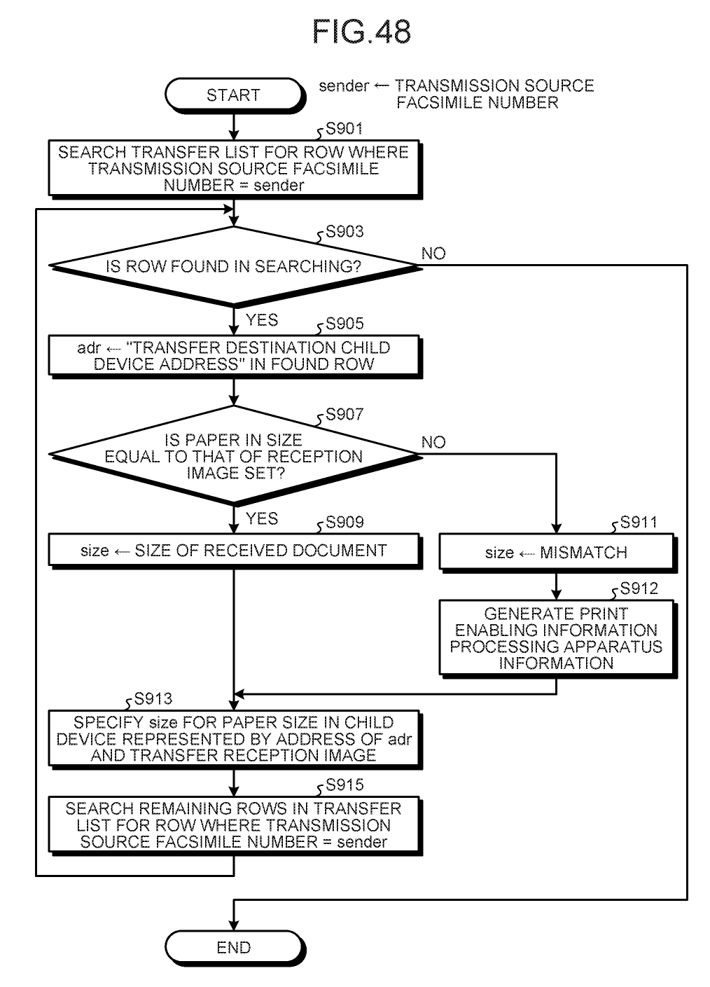

FIG. 48 is a flowchart of an exemplary transfer process that is executed by the parent device 9010 according to the modification 9.

First, the second transmitter 9133 searches the transfer list stored in the transfer information storage unit 8127 for a row of transfer information where the transmission source facsimile number matches the transmission source facsimile number (sender) received by the second receiver 131 (step S901).

When a row of transfer information where the transmission source facsimile number matches the transmission source facsimile number (sender) received by the second receiver 131 is found (YES at step S903), the second transmitter 9133 sets the transfer destination child device address in the found row of transfer information for the transfer destination (adr) to which the reception image received by the second receiver 131 is to be transferred (step S905).

When the paper size information in the found row of transfer information represents the paper size corresponding to (equal to the size of) the reception image (YES at step S907), the second transmitter 9133 sets the paper size corresponding to the reception image for the paper size (size) of paper on which the reception image received by the second receiver 131 is to be printed (step S909).

When it is NO at step S907, the second transmitter 9133 sets the size mismatch for the paper size (size) of paper on which the reception image received by the second receiver 131 is to be printed (step S911) and generates print enabling information processing apparatus information representing a child device that is able to print the paper size corresponding to the second image (step S912).

A paper size (size) is then specified in the child device 20 represented by the transfer destination child device address that is set for the transfer destination (adr) and transfers the reception image (step S913). When it is NO at step S907, the second transmitter 9133 transfers the print enabling information processing apparatus information to the child device 20.

The second transmitter 9133 then searches rows of transfer information that have not been searched in the transfer list stored in the transfer information storage unit 8127 for a row of transfer information where the transmission source facsimile number matches the transmission source facsimile number (sender) received by the second receiver 131 (step S915) and the process goes back to step S903.

When it is YES at step S903, the process goes to step S905. When it is NO at step S903, the process ends.

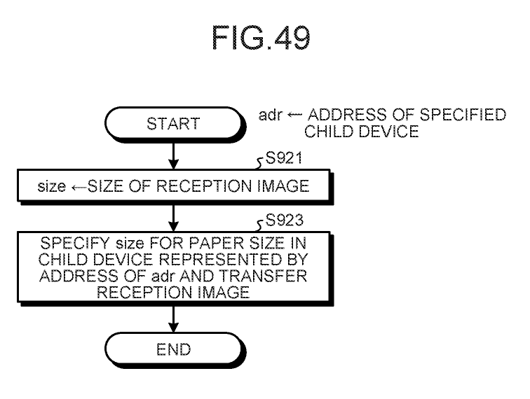

FIG. 49 is a flowchart of an exemplary transfer process that is executed by the parent device 9010 of the modification 9 when print execution information processing apparatus information is received.

First, the second transmitter 9133 sets the paper size corresponding to the reception image received by the second receiver 131 for the paper size (size) in which the reception image is to be printed (step S921).

The second transmitter 9133 then specifies the paper size (size) in the child device 9020 represented by the print execution information processing apparatus information (adr) and transfers the reception image (S923).

According to the modification 9, even when the child device 9020 is not able to print the reception image in the paper size corresponding to the reception image, the received facsimile is printed by using another child device 9020 that is able to print the paper size corresponding to the reception image, which prevents scaling-down printing and occurrence of margin and thus improves visibility of the received facsimile.

Program

The programs executed by the parent device and the child devices according to the embodiment and modifications are each provided by storing the program in a non-transitory computer-readable recording medium, such as a CD-ROM, a CD-R, a memory card, a digital versatile disk (DVD), or a flexible disk (FD) in a file in an installable or an executable form.

The programs executed by the parent device and the child devices according to the embodiment and modifications may be each provided by storing the program in a computer that is connected to a network, such as the Internet, and causing the program to be downloaded via the network. The parent device and the child devices according to the embodiment and modifications may be provided or distributed via a network, such as the Internet. The programs executed by the parent device and the child devices according to the embodiment and modifications may be each provided by previously installing the program in, for example, a ROM.

The programs executed by the parent device and the child devices according to the embodiment and modifications may have a module configuration for implementing the above-described components on a computer. As for practical hardware, for example, a CPU loads a program from a ROM into a RAM and then executes the program so that each of the above-described function units is implemented on the computer.

According to the embodiment and the modifications, there is an effect that convenience can be enhanced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A facsimile apparatus comprising:
a first receiver that receives, from any one of at least one information processing apparatus via an internal network, a first image, transmission-destination-information representing a transmission destination to which the first image is to be transmitted, and transmission-source-information-processing-apparatus-identifying-information representing an information processing apparatus serving as a transmission source from which the first image is transmitted;
a first transmitter that transmits a facsimile of the first image to the transmission destination represented by the transmission-destination-information via an external network;
a registration unit that registers, in a transfer information storage unit, transfer information that associates, with each other, first-transmission-source information where a transmission source is the transmission destination represented by the transmission-destination-information and transfer-destination-information-processing-apparatus-identifying-information where a transfer destination is the information processing apparatus represented by the transmission-source-information-processing-apparatus-identifying-information;
a second receiver that receives, via the external network, a facsimile of a second image and second transmission-source-information representing a transmission source from which the second image is transmitted; and
a second transmitter that, when the transmission source represented by the second-transmission-source-information matches the transmission source represented by the first-transmission-source-information, transmits the second image via the internal network to the information processing apparatus represented by the transfer-destination-information-processing-apparatus-identifying-information that is associated with the first-transmission-source-information.

2. The facsimile apparatus according to claim 1, wherein
each time the first transmitter transmits a facsimile, the registration unit registers the transfer information in the transfer information storage unit, and
when there are multiple sets of first-transmission-source-information each representing a transmission source that matches the transmission source represented by the second-transmission-source-information, the second transmitter transmits the second image via the internal network to the information processing apparatuses represented by sets of transfer-destination-information-processing-apparatus-identifying-information associated respectively with the sets of first-transmission-source-information.

3. The facsimile apparatus according to claim 1, wherein
the transfer information further associates the first image with the first-transmission-source-information and the transfer-destination-information-processing-apparatus-identifying-information,
each time the first transmitter transmits a facsimile, the registration unit registers the transfer information in the transfer information storage unit, and
when there are multiple sets of first-transmission-source-information each representing a transmission source that matches the transmission source represented by the second-transmission-source-information, the second transmitter transmits the second image via the internal network to the information processing apparatus represented by transfer-destination-information-processing-apparatus-identifying-information associated with a first image most similar to the second image among the first images associated respectively with the sets of first-transmission-source-information.

4. The facsimile apparatus according to claim 1, wherein
the first receiver further receives, from any one of the at least one information processing apparatus via the internal network, deletion information representing the information processing apparatus and a transmission source, and
the facsimile apparatus further comprises a deletion unit that deletes, from the transfer information storage unit, transfer information containing transfer-destination-information-processing-apparatus-identifying-information representing an information processing apparatus that matches the information processing apparatus represented by the deletion information and first-transmission-source-information representing a transmission source that matches the transmission source represented by the deletion information.

5. The facsimile apparatus according to claim 1, wherein
the first receiver receives the first image and transfer-necessary/unnecessary-information representing whether to transfer the second image that is transmitted from the transmission source that is the transmission destination represented by the transmission-destination-information; and
when the transfer-necessary/unnecessary-information represents that it is necessary to transmit the second image, the registration unit registers the transfer information into the transfer information storage unit.

6. The facsimile apparatus according to claim 1, wherein
the first receiver receives the first image and reply-necessary/unnecessary-information representing whether to accept a reply to the transmission of the facsimile of the first image, and
when the reply-necessary/unnecessary-information represents that a reply is necessary, the registration unit registers the transfer information into the transfer information storage unit, and
the facsimile apparatus further comprises a deletion unit that, when the second transmitter makes a reply by using the transfer information, deletes the transfer information from the transfer information storage unit.

7. The facsimile apparatus according to claim 6, wherein
the second transmitter transmits the second image and reply check information for checking whether making the reply has completed,
the first receiver further receives, via the internal network, reply result information representing whether making the reply has completed from the information processing apparatus to which the second image is transmitted, and
when the reply is made and the reply result information represents that the making the reply has completed, the deletion unit deletes the transfer information from the transfer information storage unit.

8. The facsimile apparatus according to claim 6, wherein
the transfer information further associates date information representing the date at which the information processing apparatus transmits the first image with the first-transmission-source-information and the transfer destination-information-processing-apparatus-identifying-information,
each time the first transmitter transmits a facsimile, the registration unit registers the transfer information in the transfer information storage unit, and
when there are multiple sets of first-transmission-source-information each representing a transmission source that matches the transmission source represented by the second-transmission-source-information, the second transmitter transmits the second image via the internal network to the information processing apparatus represented by the transfer-destination-information-processing-apparatus-identifying-information associated with the date information representing the oldest date among sets of date information associated respectively with the sets of first-transmission-source-information.

9. The facsimile apparatus according to claim 8, wherein
the second transmitter transmits the second image and reply check information for checking whether making the reply has completed,
the first receiver further receives reply result information representing whether making the reply has completed via the internal network from the information processing apparatus to which the second image is transmitted, and
when the reply result information represents that making the reply has not completed, the second transmitter transmits the second image via the internal network to the information processing apparatus represented by the transfer-destination-information-processing-apparatus-identifying-information associated with the date information representing the next oldest date following the date represented by the date information associated with the transfer-destination-information-processing-apparatus-identifying-information representing the information processing apparatus to which the second image is transmitted at the previous time among the sets of date information associated respectively with the sets of first-transmission-source-information.

10. The facsimile apparatus according to claim 9, wherein
when the reply result information received from the information processing apparatus represented by the transfer-destination-information-processing-apparatus-identifying-information associated with the date information representing the latest date among the sets of date information associated respectively with the sets of first-transmission-source-information represents that making the reply has not completed, the second transmitter transmits the second image via the internal network to an information processing apparatus that is a predetermined information processing apparatus to which the second image has not been transmitted among the at least one information processing apparatus.

11. The facsimile apparatus according to claim 8, wherein
the transfer information further associates the first image with the first-transmission-source-information, the transfer-destination-information-processing-apparatus-identifying-information, and the date information, and
when there are multiple sets of first-transmission-source-information each representing a transmission source that matches the transmission source represented by the second-transmission-source-information, the second transmitter transmits the second image via the internal network to the information processing apparatus represented by the transfer-destination-information-processing-apparatus-identifying-information that is associated with each of at least one first image having similarity with the second image exceeding a threshold among the first images associated respectively with the sets of first-transmission-source-information and with which the date information representing the oldest date is associated.

12. The facsimile apparatus according to claim 1, wherein
the transfer information further contains paper ejection destination use information acquired by the registration unit and representing each of at least one paper ejection destination represented by the transfer-destination-information-processing-apparatus-identifying-information and use of each of the at least one paper ejection destination, and
the second transmitter specifies a paper ejection destination for predetermined use among the at least one paper ejection destination represented by the paper ejection destination use information and transmits the second image to the information processing apparatus represented by the transfer-destination-information-processing-apparatus-identifying-information.

13. The facsimile apparatus according to claim 1, wherein
the transfer information further contains paper ejection destination information acquired by the registration unit and representing at least one paper ejection destination of the information processing apparatus represented by the transfer-destination-information-processing-apparatus-identifying-information, and
the second transmitter analyzes the second image, specifies a paper ejection destination corresponding to the result of analysis among the at least one paper ejection destination represented by the paper ejection destination information, and transmits the second image to the information processing apparatus represented by the transfer-destination-information-processing-apparatus-identifying-information.

14. The facsimile apparatus according to claim 1, wherein
the transfer information further contains paper size information representing a paper size printable by the information processing apparatus represented by the transfer-destination-information-processing-apparatus-identifying-information acquired by the registration unit, and
the second transmitter determines, by using the paper size information, whether the information processing apparatus represented by the transfer-destination-information-processing-apparatus-identifying-information is able to print the paper size corresponding to the second image and, when the information processing apparatus is able to print the paper size, the second transmitter specifies the paper size corresponding to the second image and transmits the second image to the information processing apparatus.

15. The facsimile apparatus according to claim 14, wherein, when the information processing apparatus represented by the transfer-destination-information-processing-apparatus-identifying-information is not able to print the paper size corresponding to the second image, the second transmitter further transmits, to the information processing apparatus, mismatch information representing that the paper size printable by the information processing apparatus mismatches the paper size corresponding to the second image.

16. The facsimile apparatus according to claim 15, wherein, when the information processing apparatus represented by the transfer-destination-information-processing-apparatus-identifying-information is not able to print the paper size corresponding to the second image, the second transmitter specifies an information processing apparatus that is able to print the paper size by using the paper size information for each of the at least one information processing apparatus and further transmits print enabling information processing apparatus information representing the specified information processing apparatus to the information processing apparatus represented by the transfer-destination-information-processing-apparatus-identifying-information.

17. The facsimile apparatus according to claim 16, wherein
the first receiver receives print execution information processing apparatus information representing an information processing apparatus that is to execute printing of the second image via the internal network from the information processing apparatus to which the mismatch information is transmitted, and
the second transmitter specifies the paper size corresponding to the second image and transmits the second image via the internal network to the information processing apparatus represented by the print execution information processing apparatus information.

18. An image transmission method comprising:
receiving, from any one of at least one information processing apparatus via an internal network, a first image, transmission-destination-information representing a transmission destination to which the first image is to be transmitted, and transmission-source-information-processing-apparatus-identifying-information representing an information processing apparatus serving as a transmission source from which the first image is transmitted;
transmitting a facsimile of the first image to the transmission destination represented by the transmission-destination-information via an external network;
registering, in a transfer information storage unit, transfer information that associates, with each other, first-transmission-source-information where a transmission source is the transmission destination represented by the transmission-destination-information and transfer-destination-information-processing-apparatus-identifying-information where a transfer destination is the information processing apparatus represented by the transmission-source-information-processing-apparatus-identifying-information;
receiving, via the external network, a facsimile of a second image and second-transmission-source-information representing a transmission source from which the second image is transmitted; and
when the transmission source represented by the second-transmission-source-information matches the transmission source represented by the first-transmission-source-information, transmitting the second image via the internal network to the information processing apparatus represented by the transfer-destination-information-processing-apparatus-identifying-information that is associated with the first-transmission-source-information.

19. A non-transitory computer-readable recording medium that contains a computer program for causing a computer to execute a process comprising:
receiving, from any one of at least one information processing apparatus via an internal network, a first image, transmission-destination-information representing a transmission destination to which the first image is to be transmitted, and transmission-source-information-processing-apparatus-identifying-information representing an information processing apparatus serving as a transmission source from which the first image is transmitted;
transmitting a facsimile of the first image to the transmission destination represented by the transmission-destination-information via an external network;
registering, in a transfer information storage unit, transfer information that associates, with each other, first-transmission-source-information where a transmission source is the transmission destination represented by the transmission-destination-information and transfer-destination-information-processing-apparatus-identifying-information where a transfer destination is the information processing apparatus represented by the transmission-source-information-processing-apparatus-identifying-information;
receiving, via the external network, a facsimile of a second image and second-transmission-source-information representing a transmission source from which the second image is transmitted; and
when the transmission source represented by the second-transmission-source-information matches the transmission source represented by the first-transmission-source-information, transmitting the second image via the internal network to the information processing apparatus represented by the transfer-destination-information-processing-apparatus-identifying-information that is associated with the first-transmission-source-information.
